(19) United States
(12) Patent Application Publication
(10) Pub. No.: US 2026/0370984 A1
(43) Pub. Date: Nov. 19, 2026

(54) LIGHT DETECTING DEVICE AND PROCESSING DEVICE

(71) Applicant: SONY SEMICONDUCTOR SOLUTIONS CORPORATION, Kanagawa (JP)

(72) Inventors: Susumu HOGYOKU, Tokyo (JP); Takeshi OYAKAWA, Tokyo (JP)

(73) Assignee: SONY SEMICONDUCTOR SOLUTIONS CORPORATION, Kanagawa (JP)

(21) Appl. No.: 19/135,692

(22) PCT Filed: Oct. 25, 2023
(86) PCT No.: PCT/JP2023/038446

§ 371 Date: Jun. 4, 2025

(30) Foreign Application Priority Data
Dec. 23, 2022 (JP) 2022-206200

(51) Int. Cl. H04N 25/78; H04N 25/77; H04N 25/79

(52) U.S. Cl. CPC H04N 25/78; H04N 25/77; H04N 25/79

(57) ABSTRACT

A light detecting device includes a sensor, neural network circuitry and a communication interface. The sensor is configured to output a plurality of first line data including a plurality of pixel data. The neural network circuitry is configured to process at least one of the plurality of first line data and output second line data including a result of the processing. The communication interface is configured to transmit a communication frame including the at least one of the plurality of first line data and the second line data and includes a first header including identification information for the at least one of the plurality of first line data, the at least one of the plurality of first line data, a second header including identification information for the second line data and the second line data.

### TECHNICAL FIELD

The present technology relates to a light detecting device. Specifically, the present technology relates to a light detecting device and a processing device.

### BACKGROUND ART

In recent years, signal processing using neural network models has increasingly been more functional and has an increasingly wider scope of application. For example, there is a device proposed in which both multiple pixels and neural network circuits are divided into multiple groups in advance, and pixel information regarding respective image groups is input to the corresponding neural network circuit groups (see PTL 1, for example).

### CITATION LIST

### Patent Literature

PTL 1: JP 2022-525794

### SUMMARY

### Technical Problem

The technology mentioned above attempts to increase the speed of processing by causing pixel information regarding respective image groups to be input to corresponding neural network circuit groups. However, in the device mentioned above, there is a risk that it becomes difficult to synchronize the output of sensors and the output of neural network circuits when they are processed. For example, Event-based Vision Sensor (EVS)s that utilize an arbiter scheme sense and output address events without synchronization with timing signals such as vertical synchronization signals, for example. In addition, for example, spike neural network circuits similarly output spike signals asynchronously. There is a problem that when these sensors or neural network circuits are used, it becomes difficult to synchronize outputs of these sensor and circuits.

The present technology has been produced in view of such a situation. It is desirable to make it easier to synchronize the output of a sensor and the output of a neural network circuit in a light sensing device that utilizes the neural network circuit.

### Solution to Problem

A light detecting device according to an embodiment of the present disclosure includes a sensor configured to output a plurality of first line data including a plurality of pixel data, neural network circuitry and a communication interface. The neural network circuitry is configured to process at least one of the plurality of first line data and output second line data including a result of the processing. The communication interface is configured to transmit a communication frame including the at least one of the plurality of first line data and the second line data. The communication interface includes a first header including identification information for the at least one of the plurality of first line data, the at least one of the plurality of first line data, a second header including identification information for the second line data and the second line data.

A processing device according to an embodiment of the present disclosure includes circuity and neural network circuitry. The circuitry is configured to receive a communication frame from a light detecting device. The light detecting device includes a sensor configured to output a plurality of first line data including a plurality of pixel data. The neural network circuitry configured to process at least one of the plurality of first line data and output second line data including a result of the processing. The communication frame includes a first header including identification information for the at least one of the plurality of first line data, the at least one of the plurality of first line data, a second header including identification information for the second line data and the second line data.

### Advantageous Effects of Invention

since the format processing section generates a communication frame having stored therein PLs and SLs in association with each other, a downstream circuit can synchronize them easily.

### BRIEF DESCRIPTION OF DRAWINGS

FIG. 1 is a block diagram depicting a configuration example of a light sensing device according to a first embodiment of the present technology.

FIG. 2 is a block diagram depicting a configuration example of a sensor chip according to the first embodiment of the present technology.

FIG. 3 is a block diagram depicting a configuration example of an Event-based Vision Sensor (EVS) according to the first embodiment of the present technology.

FIG. 4 is a circuit diagram depicting a configuration example of pixels according to the first embodiment of the present technology.

FIGS. 5A and 5B are block diagrams depicting a configuration example of a Simulated Neural Network (SNN) circuit according to the first embodiment of the present technology.

FIG. 6 is a diagram depicting an implementation example of the SNN circuit according to the first embodiment of the present technology.

FIG. 7 is a block diagram depicting a configuration example of cores according to the first embodiment of the present technology.

FIG. 8 is a block diagram depicting a configuration example of a test pattern generating section according to the first embodiment of the present technology.

FIG. 9 is a block diagram depicting a configuration example of a format processing section according to the first embodiment of the present technology.

FIGS. 10A and 10B are diagrams depicting examples of headered pixel lines and spike lines according to the first embodiment of the present technology.

FIG. 11 is a diagram depicting an example of output timings of pixel lines and spike lines according to the first embodiment of the present technology.

FIG. 12 is a diagram depicting an example of rearranged pixel lines and spike lines according to the first embodiment of the present technology.

FIG. 13 is a diagram depicting an example of a communication frame format according to the first embodiment of the present technology.

FIG. 14 is a flowchart depicting an example of operation of the light sensing device according to the first embodiment of the present technology.

FIG. 15 is a diagram depicting an example of the communication frame format according to a first modification example of the first embodiment of the present technology.

FIG. 16 is a diagram depicting an example of the communication frame format according to a second modification example of the first embodiment of the present technology.

FIG. 17 is a diagram depicting an example of a multilayered structure of the sensor chip according to a third modification example of the first embodiment of the present technology.

FIG. 18 is a circuit diagram depicting a configuration example of the pixels according to the third modification example of the first embodiment of the present technology.

FIG. 19 is a diagram depicting an example of the multilayered structure of the sensor chip according to a fourth modification example of the first embodiment of the present technology.

FIG. 20 is a block diagram depicting a configuration example of the sensor chip according to a second embodiment of the present technology.

FIG. 21 is a block diagram depicting a configuration example of the sensor chip according to a first modification example of the second embodiment of the present technology.

FIG. 22 is a block diagram depicting a configuration example of the sensor chip according to a second modification example of the second embodiment of the present technology.

FIG. 23 is a block diagram depicting a configuration example of the sensor chip according to a third embodiment of the present technology.

FIG. 24 is a block diagram depicting a configuration example of a photon measuring circuit according to the third embodiment of the present technology.

FIG. 25 is a circuit diagram depicting a configuration example of the pixels according to the third embodiment of the present technology.

FIG. 26 is a block diagram depicting a configuration example of the sensor chip according to a fourth embodiment of the present technology.

FIG. 27 is a block diagram depicting a configuration example of a Contact Image Sensor(CIS) according to the fourth embodiment of the present technology.

FIG. 28 is a circuit diagram depicting a configuration example of the pixels according to the fourth embodiment of the present technology.

FIG. 29 is a block diagram depicting a configuration example of the light sensing device according to a fifth embodiment of the present technology.

FIG. 30 is a block diagram depicting a configuration example of the sensor chip according to the fifth embodiment of the present technology.

FIG. 31 is a diagram depicting an example of the communication frame format according to the fifth embodiment of the present technology.

FIG. 32 is a block diagram depicting an example of a schematic configuration of a vehicle control system.

FIG. 33 is a diagram depicting an example of an installation position of an imaging section.

### DESCRIPTION OF EMBODIMENTS

Hereinafter, modes (hereinafter, referred to as embodiments) for embodying the present technology will be described. The description will be made in the following order.
1. First Embodiment (an example in which pixel lines and spike lines are stored in a communication frame)
2. Second Embodiment (an example in which pixel lines and spike lines are stored in a communication frame, and circuits are eliminated)
3. Third Embodiment (an example in which pixel lines and spike lines are stored in a communication frame, and a photon measuring circuit is used)
4. Fourth Embodiment (an example in which pixel lines and spike lines are stored in a communication frame, and a CIS is used)
5. Fifth Embodiment (an example in which spike lines are stored in a communication frame)
6. Examples of Application to Mobile Body

### 1. First Embodiment

### “Configuration Example of Light Sensing Device”

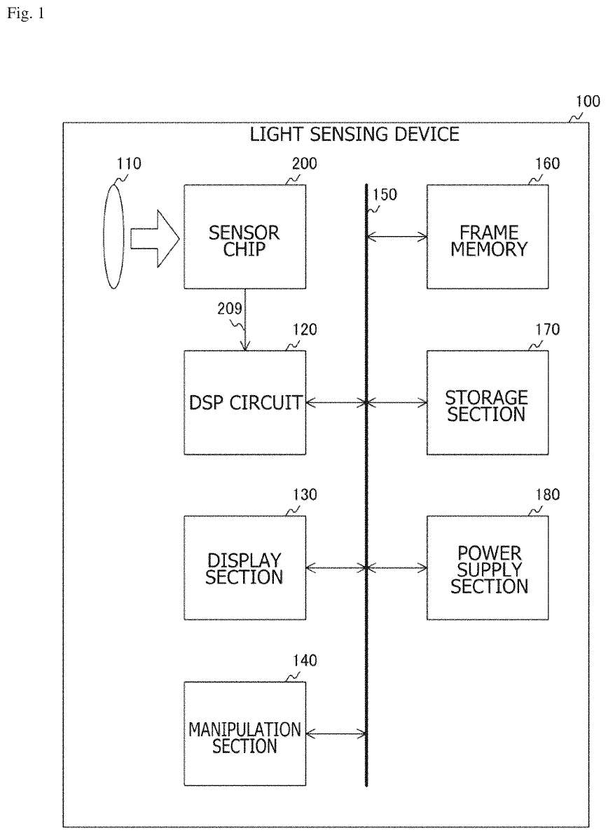

FIG. 1 is a block diagram depicting a configuration example of a light sensing device 100 according to a first embodiment of the present technology. The light sensing device 100 includes an optics section 110, a sensor chip 200 and a DSP (Digital Signal Processing) circuit 120. Furthermore, the light sensing device 100 includes a display section 130, a manipulation section 140, a bus 150, a frame memory 160, a storage section 170, and a power supply section 180. Conceivable examples of the light sensing device 100 include, for example, a smartphone, a personal computer, an in-vehicle camera, and the like, in addition to a digital camera such as a digital still camera.

The optics section 110 condenses light from an imaging subject and guides the light to the sensor chip 200. The sensor chip 200 generates and processes multiple pieces of pixel data by photoelectric conversion. The sensor chip 200 supplies the pixel data after being processed into image data 209 to the DSP circuit 120.

The DSP circuit 120 executes predetermined signal processing on the image data 209 from the sensor chip 200. The DSP circuit 120 outputs the image data 209 after the processing to the frame memory 160, or the like, via the bus 150. According to one embodiment of the present disclosure, a predetermined signal processing includes a neural network signal processing utilizing neural network circuitry as discussed in greater detail below.

The display section 130 displays image data or the like. Conceivable examples of the display section 130 include, for example, a liquid crystal panel and an organic Electro Luminescence (EL) panel. The manipulation section 140 generates a manipulation signal according to user manipulation.

The bus 150 is a common path through which the optics section 110, the sensor chip 200, the DSP circuit 120, the display section 130, the manipulation section 140, the frame memory 160, the storage section 170, and the power supply section 180 exchange data with each other.

The storage section 170 stores various types of data such as image data. The power supply section 180 supplies power to the sensor chip 200, the DSP circuit 120, the display section 130, and the like.

### “Configuration Example of Sensor Chip”

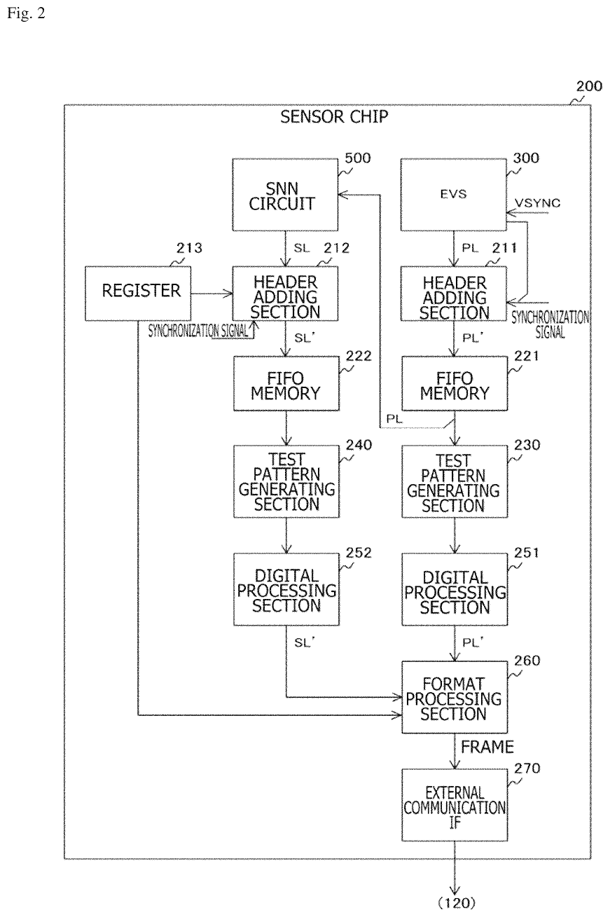

FIG. 2 is a block diagram depicting a configuration example of the sensor chip 200 according to the first embodiment of the present technology. The sensor chip 200 is a single semiconductor chip, and includes an Event-based Vision Sensor (EVS) 300, a Simulated Neural Network (SNN) circuit 500, header adding sections 211 and 212, and a register 213. Furthermore, the sensor chip 200 includes First-In First-Out (FIFO) memories 221 and 222, test pattern generating sections 230 and 240, digital processing sections 251 and 252, a format processing section 260, and an external communication interface 270.

The EVS 300 senses luminance changes of each pixel. In synchronization with a vertical synchronization signal (VSYNC), the EVS 300 internally generates a horizontal synchronization signal (HSYNC) having a higher frequency, and supplies the horizontal synchronization signal HSYNC to the header adding sections 211 and 212. In addition, in synchronization with the horizontal synchronization signal HSYNC, the EVS 300 sequentially selects multiple lines, and reads out line data including arrayed pieces of pixel data of pixels in each line of the lines as a Pixel Line (PL). Then, the EVS 300 outputs each of the PLs to the header adding section 211. Each piece of the pixel data includes a bit representing a result of sensing a luminance change of the pixel, for example. Note that the EVS 300 is an example of a sensor described in the claims. In addition, PLs are an example of first line data described in the claims.

The header adding section 211 generates a header including time information representing a time at which a PL has been output, and adds the time information to the PL. The vertical synchronization signal VSYNC and the horizontal synchronization signal HSYNC are input to the header adding section 211 as synchronization signals. For example, in synchronization with the horizontal synchronization signal HSYNC in a 1-V period represented by the vertical synchronization signal VSYNC, the header adding section 211 generates time information regarding an output time represented by the signal, stores the time information in a header, and adds the header to a PL. Hereinbelow, a PL to which a header has been added is written as “PL′.” The header adding section 211 supplies a headered PL′ to the FIFO memory 221.

Note that the header adding section 211 is an example of a first header adding section described in the claims, and headers added to PLs are examples of first headers described in the claims.

The FIFO memory 221 retains PL's from the header adding section 211 by a (FIFO)scheme. The headered PL's are read out by the test pattern generating section 230. In addition, headerless PLs are read out by the SNN circuit 500.

The SNN circuit 500 processes two or more PLs based on an SNN model, and generates, as Spike Line (SL)s, line data including respective sequentially arrayed processing results. SLs are data including chronologically arrayed bits each representing whether or not a spike has occurred in a predetermined period. The SNN circuit 500 outputs SLs to the header adding section 212. A rate between an output frequency of the EVS 300 and an output frequency of the SNN circuit 500 is controlled to be a constant value (8:1, etc.).

Note that, instead of the SNN circuit 500, a Neural Network (NN) circuit other than an SNN circuit can also be used. In addition, the SNN circuit 500 is an example of a neural network circuit described in the claims. In addition, SLs are examples of second line data described in the claims.

The header adding section 212 generates a header including time information, and adds the header to an SL.

The vertical synchronization signal VSYNC and the horizontal synchronization signal HSYNC are input also to the header adding section 212 as synchronization signals. Since an SL is generated from two or more PLs by the SNN circuit 500, an output time of the SL is delayed relative to the output time of the beginning of a PL group. It is assumed that the delay Tdelay is determined in advance by calculation or measurement and retained in the register 213. The header adding section 212 reads out the delay Tdelay from the register 213 and acquires a time which is before the current time represented by the horizontal synchronization signal HSYNC in a 1-V period. The header adding section 212 stores time information regarding the time in the header, and adds the header to the SL. Hereinbelow, SLs to which headers have been added are written as “SL's.” The header adding section 212 supplies the headered SL′ to the FIFO memory 222.

With the processes mentioned above, identical time information is stored in the header added to an SL and a header added to the beginning of the PL group corresponding to the SL. Because of this, by referring to the headers, a downstream circuit can easily synchronize the PL group and the SL.

Note that the header adding section 212 is an example of a second header adding section described in the claims, and headers added to SLs are examples of second headers described in claims.

The FIFO memory 222 retains SL's from the header adding section 212 by a FIFO scheme. The headered SL's are read out by the test pattern generating section 240.

The test pattern generating section 230 generates a predetermined test pattern in a test mode. In the test mode, the test pattern generating section 230 supplies the test pattern to the digital processing section 251, and in a non-test mode, the test pattern generating section 230 supplies PL's to the digital processing section 251.

The test pattern generating section 240 generates a predetermined test pattern in the test mode. In the test mode, the test pattern generating section 240 supplies the test pattern to the digital processing section 252, and in a non-test mode, the test pattern generating section 240 supplies SL's to the digital processing section 252.

Note that the test pattern generating sections 230 and 240 are arranged as necessary. In a case where these are unnecessary, PL's and SL's from the FIFO memories 221 and 222, respectively, are directly input to the digital processing sections 251 and 252, respectively.

The digital processing section 251 performs various types of digital processing on PL's. The digital processing section 251 supplies the PL's after processing to the format processing section 260.

The digital processing section 252 performs various types of digital processing on SL's as necessary. The digital processing section 252 supplies the SL's after processing to the format processing section 260. For example, the digital processing section 252 can perform a process of acquiring class values or regression values as recognition results of the SNN circuit 500 by counting the number of spikes of each SL and comparing the count value with a threshold value. Results of the processing are output to the format processing section 260 as necessary.

The format processing section 260 generates a communication frame having stored therein, SL's and PL's in association with each other. This format processing section 260 supplies the generated communication frame to the external communication interface 270.

The external communication interface 270 transmits the communication frame from the format processing section 260 to the DSP circuit 120 or the like. As a communication standard of the external communication interface 270, Mobile Industry Processor Interface (MIPI) is used, for example.

### “Configuration Example of EVS”

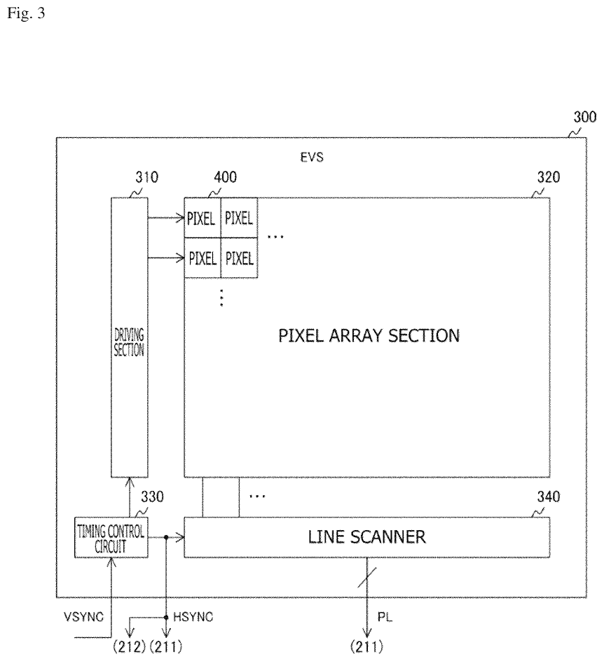

FIG. 3 is a block diagram depicting a configuration example of the EVS 300 according to the first embodiment of the present technology. The EVS 300 includes a driving section 310, a pixel array section 320, a timing control circuit 330 and a line scanner 340. Multiple pixels 400 are arrayed in a two-dimensional grid in the pixel array section 320.

The driving section 310 drives each of the pixels 400. The pixels 400 sense whether there are luminance changes and generate pixel data representing results of the sensing.

The timing control circuit 330 controls timings to drive the driving section 310 and the line scanner 340. The vertical synchronization signal VSYNC is input to the timing control circuit 330. The timing control circuit 330 generates the horizontal synchronization signal HSYNC from the vertical synchronization signal VSYNC and supplies the horizontal synchronization signal HSYNC to the line scanner 340 and the header adding sections 211 and 212.

In synchronization with the horizontal synchronization signal HSYNC, the line scanner 340 sequentially selects lines (rows, columns, etc.) and reads out pixel data of each pixel in each selected line. The line scanner 340 arrays the pixel data read out from a line one-dimensionally and outputs the data to the header adding section 211 as a PL. Note that it is assumed that a readout operation is performed in units of lines, but instead the readout operation can also be performed in units of areas. In this case, the line scanner 340 scans arrays each piece of pixel data read out from a selected area one-dimensionally in a predetermined order and outputs the pixel data as a PL.

As illustrated in the diagram, control performed to sequentially read out pixel data in units of lines or areas in synchronization with a synchronization signal such as an HSYNC signal is called a scan scheme. Note that the EVS 300 can also use an arbiter scheme in which pixel data is read out without synchronization with synchronization signals, as mentioned later.

### “Configuration Example of Pixels”

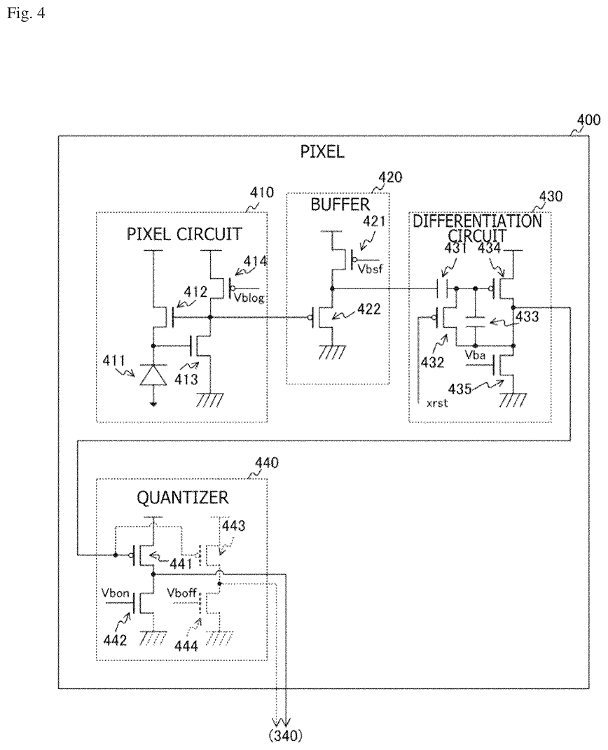

FIG. 4 is a circuit diagram depicting a configuration example of the pixels 400 according to the first embodiment of the present technology. Each of the pixels 400 includes a pixel circuit 410, a buffer 420, a differentiation circuit 430 and a quantizer 440.

The pixel circuit 410 includes a photodiode 411, negative channel Metal-Oxide-Semiconductor (nMOS) transistors 412 and 413 and a positive channel (pMOS) transistor 414.

The photodiode 411 generates a photocurrent by photoelectric conversion of incident light. The nMOS transistor 412 is inserted between a power supply and the photodiode 411. The pMOS transistor 414 and the nMOS transistor 413 are connected in series between the power supply and a ground terminal. In addition, the gate of the nMOS transistor 413 is connected between the nMOS transistor 412 and the photodiode 411. A bias voltage Vblog is applied to the gate of the pMOS transistor 414.

The buffer 420 includes pMOS transistors 421 and 422 connected in series between the power supply and a ground terminal. The gate of the grounded side pMOS transistor 422 is connected between the pMOS transistor 414 and the nMOS transistor 413. A bias voltage Vbsf is applied to the gate of the power-supply-side pMOS transistor 421. In addition, the differentiation circuit 403 is connected between the pMOS transistors 421 and 422.

With the circuit mentioned above, a voltage signal according to a photocurrent is generated and output from the buffer 420.

The differentiation circuit 430 includes capacitors 431 and 433, pMOS transistors 432 and 434 and an nMOS transistor 435.

One end of the capacitor 431 is connected to the buffer 420, and the other end of the capacitor 431 is connected to one end of the capacitor 433 and the gate of the pMOS transistor 434. A reset signal xrst is input to the gate of the pMOS transistor 432 and the source and drain are connected to both ends of the capacitor 433. The pMOS transistor 434 and the nMOS transistor 435 are connected in series between the power supply and a ground terminal. In addition, the other end of the capacitor 433 is connected between the pMOS transistor 434 and the nMOS transistor 435. A bias voltage Vba is applied to the gate of the grounded-side nMOS transistor 435, and the quantizer 440 is connected between the pMOS transistor 434 and the nMOS transistor 435. With such connections, a differential signal representing change amounts of a voltage signal is generated and output to the quantizer 440. In addition, the differential signal is initialized by the reset signal xrst.

The quantizer 440 includes a pMOS transistor 441 and an nMOS transistor 442 connected in series between the power supply and a ground terminal. The gate of the pMOS transistor 441 is connected to the differentiation circuit 430 and a predetermined upper threshold Vbon is applied to the gate of the nMOS transistor 442. A voltage signal between the pMOS transistor 441 and the nMOS transistor 442 is read out by the line scanner 340 as a luminance-change sensing signal.

In the diagram, an ON event is sensed when a differential signal representing a change in luminance exceeds the upper threshold value Vbon. Note that the pixel 400 can also sense an OFF event when the differential signal falls below a lower threshold value Vboff. In this case, a pMOS transistor 443 and an nMOS transistor 444 connected in series between the power supply and a ground terminal are added. The gate of the pMOS transistor 443 is connected to the differentiation circuit 430, and the lower threshold Vboff is applied to the gate of the nMOS transistor 444. The pixel 400 may sense both the ON event and the OFF event or may sense only either one of them.

### “Configuration Example of SNN Circuit”

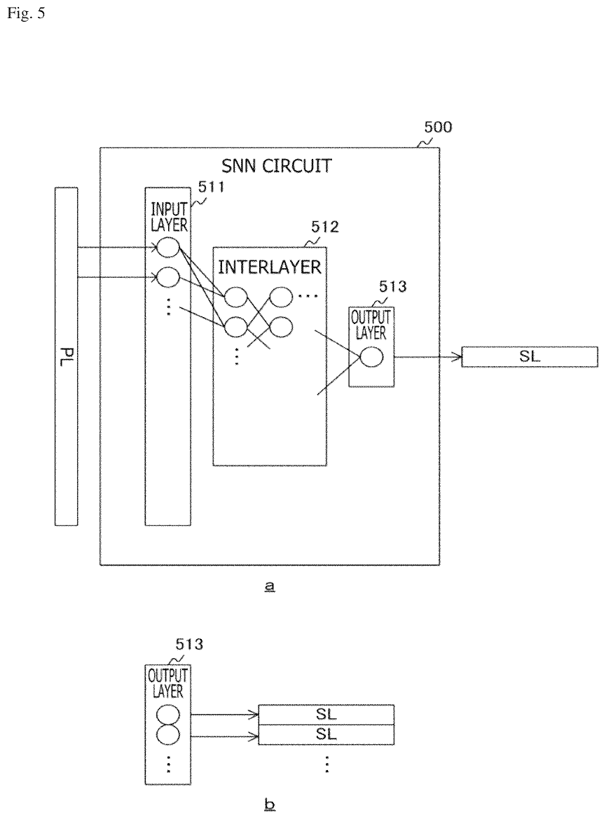

FIG. 5A is a block diagram depicting a configuration example of the SNN circuit 500. The SNN circuit 500 includes an input layer 511, an interlayer 512, and an output layer 513 as illustrated in the diagram.

PLs are input to the input layer 511. One or more layers are arranged in the interlayer 512. A neuron of an upstream layer is connected with a neuron of the next layer, and a calculation result of the upstream layer is passed to the next layer. The output layer 513 generates spike signals asynchronously. Data including chronologically arrayed spike signals generated in a predetermined period is output as an SL. A predetermined number of two or more PLs are sequentially input to the SNN circuit 500, and thereby one SL is generated.

Note that the output layer 513 includes multiple neurons, and can also output multiple SLs in parallel, as illustrated in FIG. 5B as discussed below.

In addition, the data size of output of the SNN circuit 500 can be changed depending on network settings. In a case where multi-dimensional data is output as illustrated in FIG. 5B, the data may be output sequentially by being divided into one-dimensional lines.

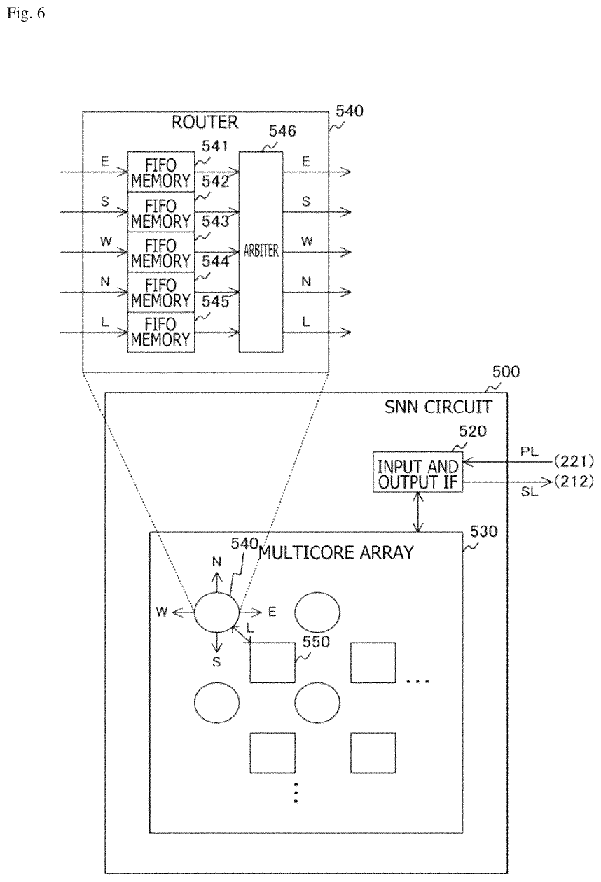

FIG. 6 is a diagram depicting an implementation example of the SNN circuit 500 according to the first embodiment of the present technology. The SNN circuit 500 in FIG. 5 is realized by a circuit in FIG. 6, for example. As illustrated in FIG. 6, the SNN circuit 500 includes, an input/output (I/F) interface 520 and a multicore array 530, for example.

The I/F interface 520 performs data transmission and reception between the outside and the multicore array 530. The I/F interface 520 supplies, to a multicore array, PLS input from the FIFO memory 221, and supplies, to the header adding section 212, SLs from the multicore array 530.

The multicore array 530 includes multiple cores 550 arrayed in a two-dimensional grid. Routers 540 are arranged adjacent to the respective cores 550.

The routers 540 control data paths. Each router 540 include FIFO memories 541 to 545 and an arbiter 546, for example. “E” in the diagram represents the east direction from a router 540 of interest, and “S” represents the south direction from the router 540 of interest. “W” represents the west direction, and “N” represents the north direction. “L” represents a direction towards a core 550 adjacent to the router 540.

The FIFO memory 541 retains data from the east direction by a FIFO scheme, and outputs a request to the arbiter 546. The FIFO memory 542 retains data from the south direction by a FIFO scheme, and outputs a request to the arbiter 546. The FIFO memory 543 retains data from the west direction by a FIFO scheme, and outputs a request to the arbiter 546. The FIFO memory 544 retains data from the north direction by a FIFO scheme, and outputs a request to the arbiter 546. The FIFO memory 545 retains data from the adjacent core 550 by a FIFO scheme, and outputs a request to the arbiter 546.

Note that the external FIFO memory 221 can also be eliminated and the FIFO memory 541 in the SNN circuit 500, or the like, may serve as a substitute.

The arbiter 546 arbitrates between the requests from the FIFO memories 541 to 545 and returns responses. Upon receiving a response, a FIFO memory outputs, via the arbiter 546, data to any of the cores 550 that are located east, west, south and north and adjacent to the FIFO memory.

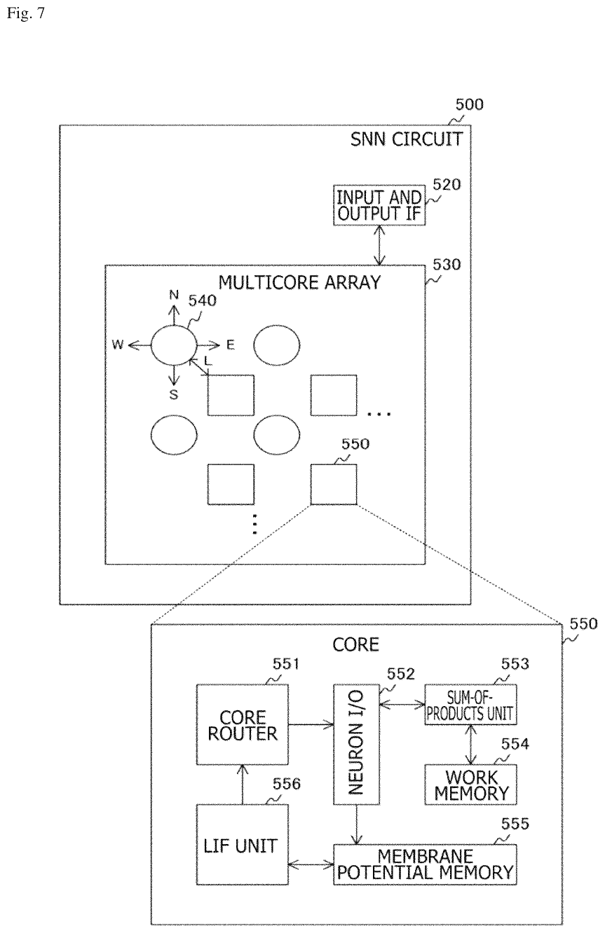

FIG. 7 is a block diagram depicting a configuration example of the cores 550 according to the first embodiment of the present technology. A core 550 includes a core router 551, a neuron I/O 552, a sum-of-products unit 553, a work memory 554, a membrane potential memory 555, and a Leaky Integrate and Fire (LIF) unit 556.

The core router 551 supplies data from an adjacent router 540 to the neuron I/O 552 and supplies data from the LIF unit 556 to the adjacent router 540.

The sum-of-products unit 553 integrates data from the neuron I/O 552 by using the work memory 554. The membrane potential memory 555 retains a membrane potential obtained by the integration. The LIF unit 556 determines whether the membrane potential has exceeded a predetermined threshold value and ignited (i.e., a spike has occurred) and supplies a result of the determination to the core router 551.

### “Configuration Example of Test Pattern Generating Section”

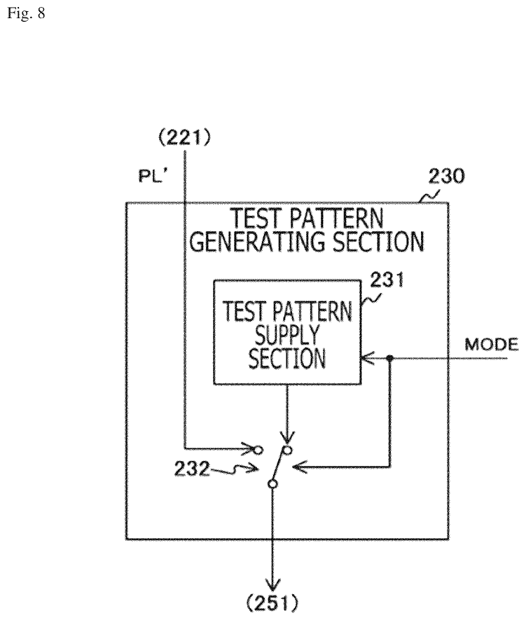

FIG. 8 is a block diagram depicting a configuration example of the test pattern generating section 230 according to the first embodiment of the present technology. The test pattern generating section 230 includes a test pattern supply section 231 and a switch 232.

The test pattern supply section 231 generates a predetermined test pattern and supplies the predetermined test pattern to the switch 232 in a case where a test mode has been started due to a control signal MODE.

The switch 232 supplies the test pattern to the digital processing section 251 in a case where the test mode has been started and supplies PL's from the FIFO memory 221 to the digital processing section 251 in a case where a non-test mode has been started.

Note that the configuration of the test pattern generating section 240 is similar to the configuration of the test pattern generating section 230.

### “Configuration Example of Format Processing Section”

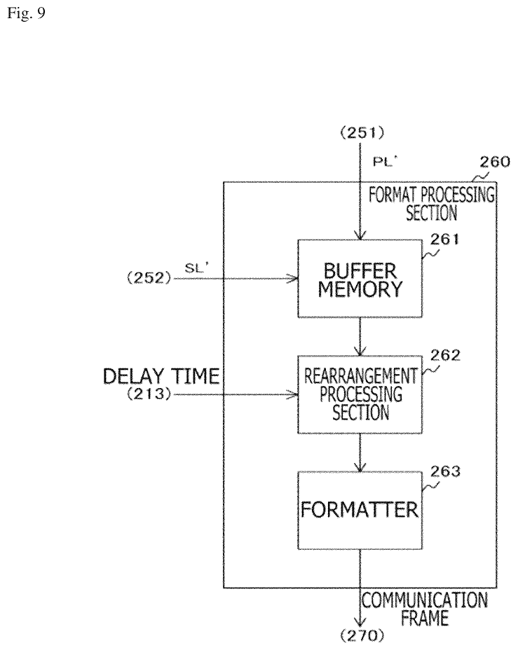

FIG. 9 is a block diagram depicting a configuration example of the format processing section 260 according to the first embodiment of the present technology. The format processing section 260 includes a buffer memory 261, a rearrangement processing section 262 and a formatter 263.

The buffer memory 261 temporarily retains PL's and SL's from the digital processing sections 251 and 252, respectively.

The rearrangement processing section 262 reads out PL's and SL's from the buffer memory 261 and rearranges their arrays on the basis of the delay retained in the register 213. Details of the rearrangement process are mentioned later. The rearrangement processing section 262 supplies the PL's and SL's after the rearrangement to the formatter 263.

The formatter 263 generates a communication frame in a format conforming to a predetermined communication standard. The formatter 263 adds a footer to each of a headered PL′ and SL′, stores the data in the communication frame, and supplies the communication frame to the external communication interface 270.

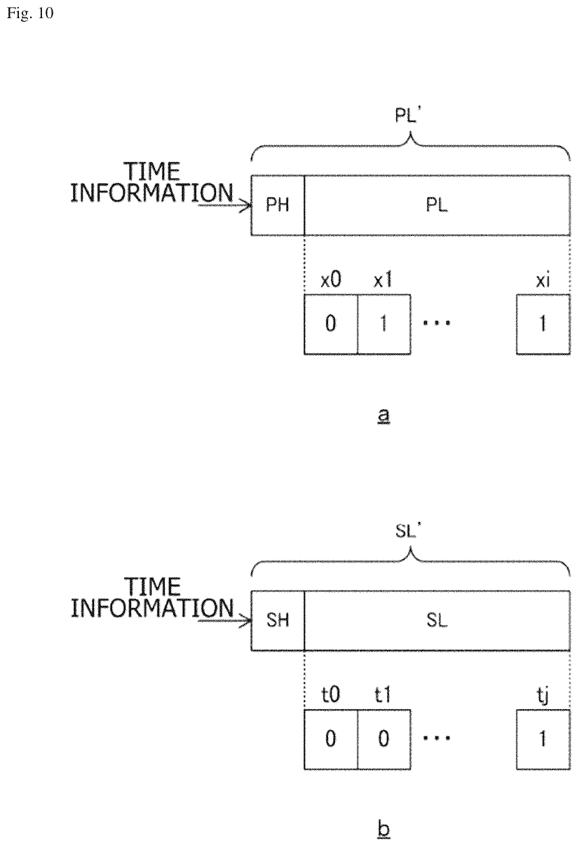

FIGS. 10A and 10B are diagrams depicting examples of headered PL's and SL's according to the first embodiment of the present technology. FIG. 10A depicts an example of PL's and FIG. 10B depicts an example of SL's.

As illustrated in FIG. 10A, a PL′ includes a Pixel Header (PH) and a PL. The PH has time information stored therein, for example. The PL includes multiple pieces of pixel data. Each piece of the pixel data is one-bit information representing whether or not an ON event has been sensed, for example. X0 to xi in the diagram represent the x-coordinates of pixels in a line to which a y coordinate is allocated. Note that, in a case where both an ON event and an OFF event are sensed, two-bit information is stored for each pixel.

As illustrated in FIG. 10B, an SL′ includes a Spike Header (SH) and an SL. The SH has time information stored therein, for example. The SL has multiple chronologically arrayed spike signals output in a predetermined period. Each of the spike signals is one-bit information representing whether a spike occurs. T0 to tj in the diagram represent times at which spike signals have been output. Note that the SNN circuit 500 can also output values of membrane potentials chronologically, instead of SLs. In this case, line data including chronologically arrayed digital values each represented by two or more bits representing a membrane potential is output.

Note that the header adding sections 211 and 212 store time information in headers, but this configuration is not the sole example. For example, instead of time information, the header adding sections 211 and 212 can also store, in headers, identification information (line numbers, etc.) of corresponding lines.

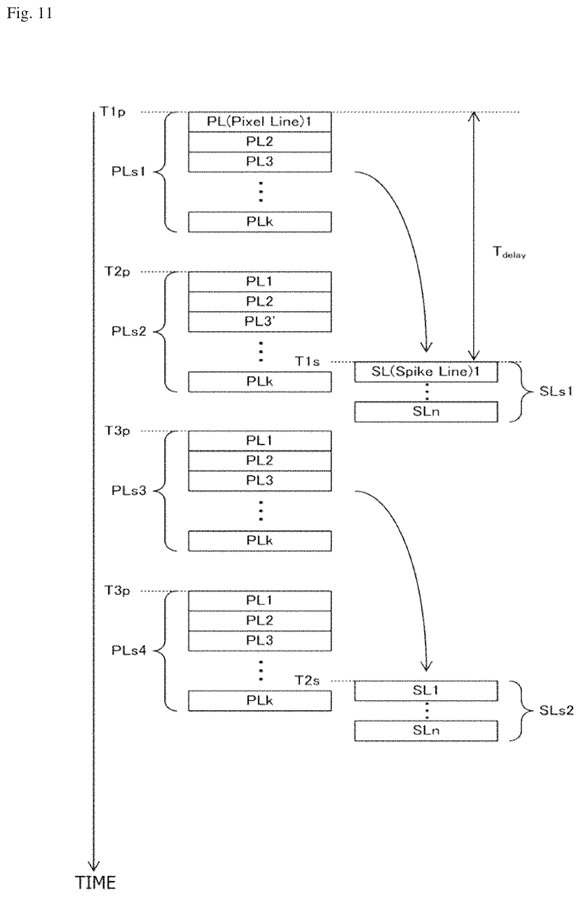

FIG. 11 is a diagram depicting an example of output timings of pixel lines and spike lines according to the first embodiment of the present technology. It is assumed that one piece of image data includes PL1 to PLk.

In the diagram, the first image data PLs1 is output from the EVS 300 at or after a timing T1p. At or after a timing T2p which is a predetermined blanking period after the second image data, PLs2 is output. Subsequently, at or after a timing T3p which is a blanking period after the third image data PLs3 is output and at or after a timing T4p, the fourth image data PLs4 is output.

On the other hand, the SNN circuit 500 sequentially outputs SL1 to SLn for SLs1 at or after a timing T1s which is after PLs1 has been processed and while PLs2 is being output. The SL group is referred to as SLs1 and SLs2 as discussed throughout. Then, the SNN circuit 500 sequentially outputs SL1 to SLn for SLs2 at or after a timing T2s which is after PLs3 has been processed and while PLs4 is being output. The SL group is referred to as SLs2. Since the EVS 300 and the SNN circuit 500 are operating in parallel, the SNN circuit 500 continues outputting SLs in a blanking period as illustrated in the diagram, in some cases.

As illustrated in the diagram, relative to the output timing of the beginning of a PL group, an output timing of an SL corresponding to the PL group is delayed. For example, the difference between the output timing T1p of PL1 at the beginning of PLs1 and the output timing T1s of SL1 at the beginning of SLs1 corresponding to the PL group corresponds to the delay Tdelay of SL1. The register 213 retains this delay Tdelay.

The rearrangement processing section 262 rearranges the array of PLs and SLs based on the delay in the register 213 such that synchronization becomes easier. For example, since SLs1 is generated from PLs1, next to PLs1, a corresponding SLs1 is arrayed.

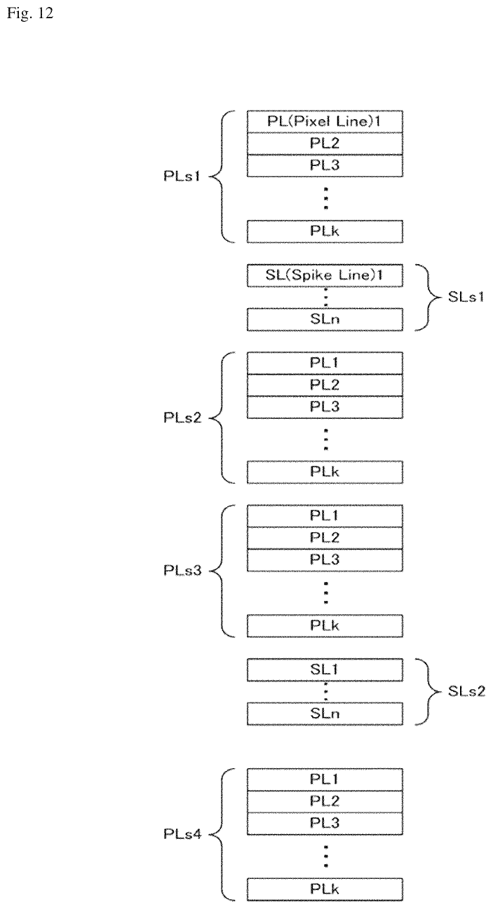

FIG. 12 is a diagram depicting an example of rearranged pixel lines and spike lines according to the first embodiment of the present technology. As illustrated in the diagram, next to PLs1, a corresponding SLs1 is arrayed. Subsequently, PLs2 and PLs3are arrayed, and SLs2 corresponding to PLs3 is arrayed. Then, PLs4 is arrayed.

As illustrated in the diagram, by arraying a PL and an SL corresponding to the PL adjacent to each other, a downstream circuit can synchronize them easily.

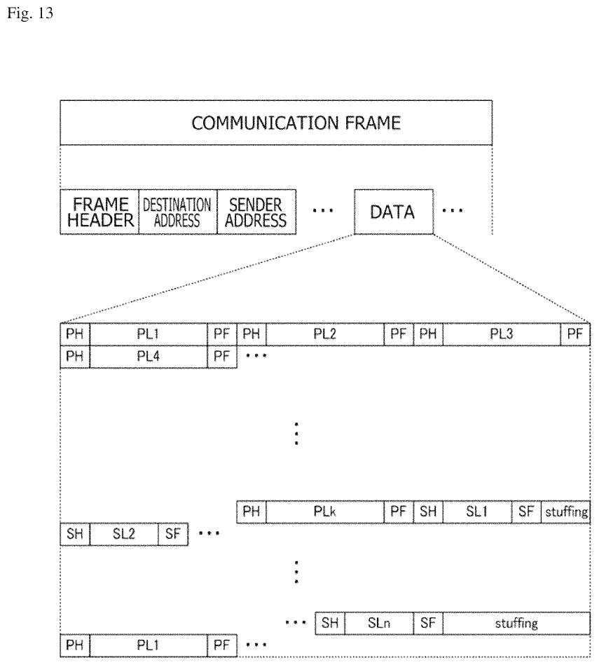

FIG. 13 is a diagram depicting an example of a communication frame format according to the first embodiment of the present technology. A communication frame stores a frame header, a destination address, a sender address and data. PL1 to PLk are stored sequentially in the data. The header adding section 211 adds a PH to each of the PLs. In addition, the formatter 263 adds a Pixel Footer (PF) to each of the PLs.

Then, next to PLk, SL1 to SLn are stored sequentially. The header adding section 212 adds an SH to each of the SLs. In addition, the formatter 263 adds a Spike Footer (SF) to each of the SLs.

In addition, in order to adjust the data size, the formatter 263 inserts stuffing data as necessary.

As illustrated in the diagram, the format processing section 260 generates a communication frame having stored therein PLs and SLs in association with each other.

Thereby, a downstream circuit can synchronize the PLs and the SLs easily.

### “Operation Example of Light Sensing Device”

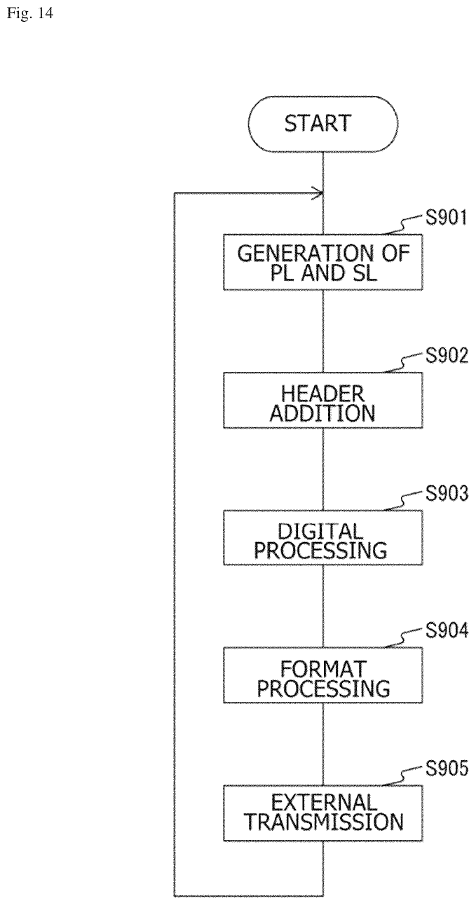

FIG. 14 is a flowchart depicting an example of an operation of the light sensing device 100 according to the first embodiment of the present technology. This operation is started when a predetermined application for capturing image data is executed, for example.

The EVS 300 and the SNN circuit 500 generate PLs and SLs, respectively, (Step S901). In addition, the header adding sections 211 and 212 add headers to PLs and SLs, respectively, (Step S902). In addition, the digital processing sections 251 and 252 perform digital processing on the headered PL's and SL's, respectively, (Step S903). In addition, the format processing section 260 generates a communication frame by format processing (Step S904) and the external communication interface 270 externally transmits the communication frame (Step S905). After Step S905, Step S901 and steps thereafter are executed repeatedly.

In this manner, according to the first embodiment of the present technology, since the format processing section 260 generates a communication frame having stored therein PLs and SLs in association with each other, a downstream circuit can synchronize them easily.

### “First Modification Example”

Whereas the header adding sections 211 and 212 add a header for each PL or each SL according to the first embodiment mentioned above, this format is not the sole example. The light sensing device 100 according to the first modification example of the first embodiment is different from the first embodiment in that a header is add only to the beginning of each of a PL group and an SL group.

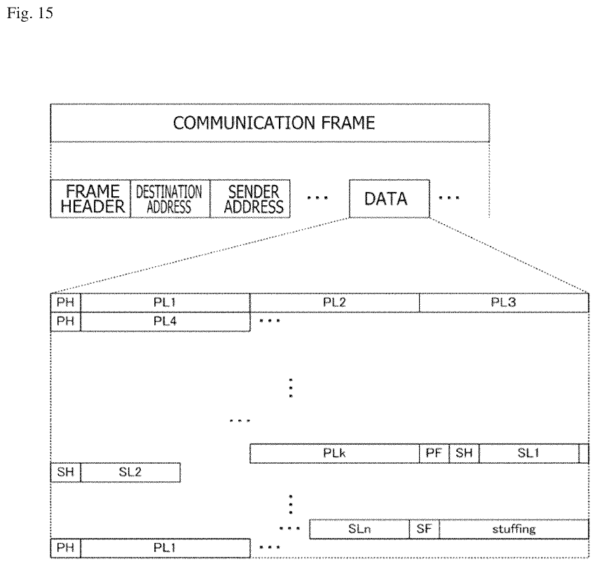

FIG. 15 is a diagram depicting an example of the communication frame format according to the first modification example of the first embodiment of the present technology. According to the first modification example of the first embodiment, the header adding section 211 adds a PH only to PL1 at the beginning of the PL group (PL1 to PLk) included in the image data. For example, timing information regarding a time at which the PL at the beginning of the PL group (PL1 to PLk) has been output or identification information regarding a line or frame at the beginning is stored in the PH. In addition, the formatter 263 adds a PF only to a PLk at the end of the group PL (PL1 to PLk).

In addition, the header adding section 212 adds an SH only to SL1 at the beginning of the SL group (SL1 to SLn) corresponding to the PL group (PL1 to PLk). In addition, the formatter 263 adds an SF only to an SLn at the end of the SL group (SL1 to SLn).

As illustrated in the diagram, by adding a header to the beginning of each of a PL group and an SL group, it is possible to reduce processing amounts of the header adding sections 211 and 212 as compared with the case where a header is added for each PL and for each SL in the PL group and the SL group, respectively. In addition, by adding a footer to the end of each of a PL group and an SL group, it is possible to reduce a processing amount of the formatter 263 as compared with the case where a footer is added for each PL and for each SL in the PL group and the SL group, respectively. Furthermore, the data sizes of a PL group and an SL group can be reduced.

In this manner, according to the first modification example of the first embodiment of the present technology, since the header adding section 211 or 212 adds a header to the beginning of each of a PL group and an SL group, processing amounts and data sizes can be reduced.

### “Second Modification Example”

Whereas the EVS 300 uses a scan scheme in which synchronicity is maintained with synchronization signals according to the first embodiment mentioned above, an asynchronous arbiter scheme can also be used instead of a scan scheme. The light sensing device 100 according to second modification example of the first embodiment is different from the first embodiment in that an arbiter scheme is used.

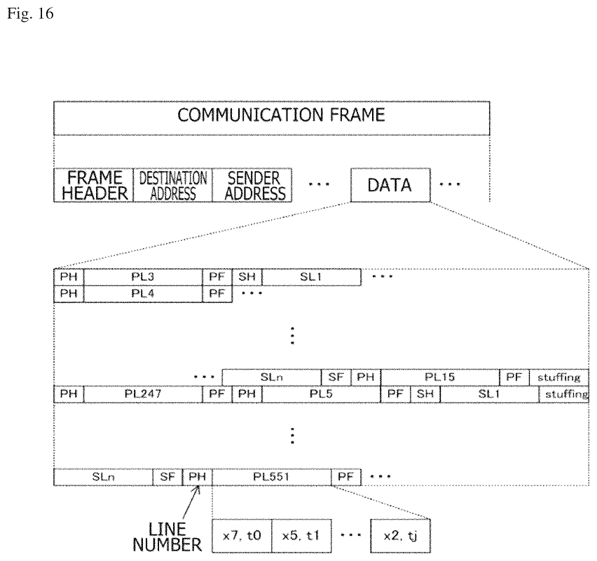

FIG. 16 is a diagram depicting an example of the communication frame format according to the second modification example of the first embodiment of the present technology. According to the second modification example of the first embodiment, the EVS 300 generates and outputs PLs by an arbiter scheme in which synchronicity with synchronization signals is not maintained. PL1 to PLk are output not in a fixed order but in an order of sensing of address events.

In addition, for each pixel in a line, a PL includes an x-coordinate of and time information regarding the pixel. This time information represents a time at which an address event has been sensed. For example, in the diagram, “x7,t0” represents that an address event is sensed at time to at a pixel located at coordinate x7.

Since time information is included in the PLs in a case of the arbiter scheme, the header adding section 211 stores, in PHs, identification information regarding areas or lines (line numbers, etc.). In addition, the header adding section 212 also stores identification information in SHs.

In this manner, according to the second modification example of the first embodiment of the present technology, since the header adding sections 211 and 212 store line numbers, or the like, in the headers, it is possible to maintain synchronicity between PLs and SLs even in a case where the arbiter scheme is used.

### “Third Modification Example”

Whereas circuits such as the EVS 300 are arranged on a single semiconductor chip according to the first embodiment mentioned above, this configuration poses a difficulty in terms of an increases of pixels, in some cases. The light sensing device 100 according to the third modification example of the first embodiment is different from the first embodiment in that circuits are arranged in a distributed manner on two stacked semiconductor chips.

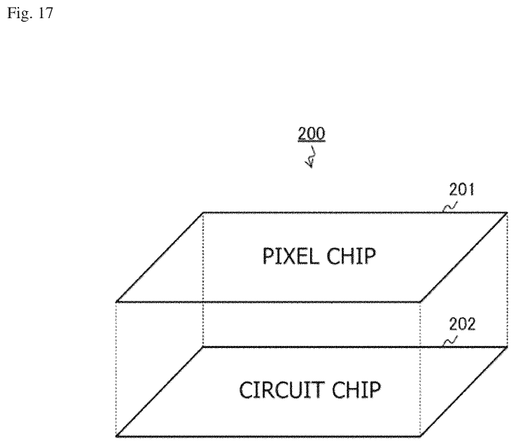

FIG. 17 is a diagram depicting an example of a multilayered structure of the sensor chip 200 according to the third modification example of the first embodiment of the present technology. The sensor chip 200 according to the third modification example of the first embodiment includes a pixel chip 201 and a circuit chip 202. These chips are stacked one on another, and are electrically connected by copper-copper (Cu—Cu) bonding, for example. Note that other than Cu—Cu bonding, they can also be connected by vias or bumps.

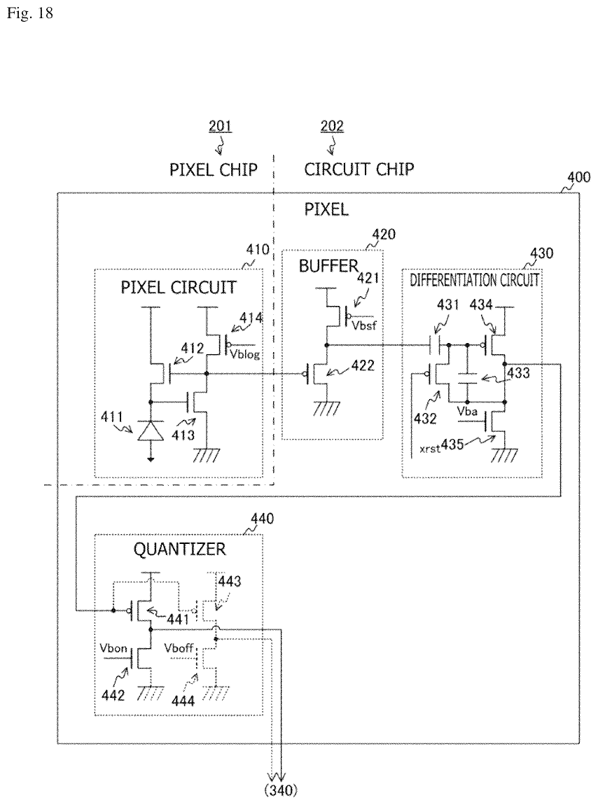

FIG. 18 is a circuit diagram depicting a configuration example of the pixels 400 according to the third modification example of the first embodiment of the present technology. For example, the pixel circuit 410 in the pixel 400 is arranged on the pixel chip 201, and downstream circuits such as the buffer 420 and circuits thereafter are arranged on the circuit chip 202.

Note that circuits to be arranged on each chip are not limited to those illustrated in the diagram. For example, it is also possible to arrange the photodiode 411, and the nMOS transistors 412 and 413 on the pixel chip 201, and to arrange the remaining circuits on the circuit chip 202. Alternatively, it is also possible to arrange only the photodiode 411 on the pixel chip 201, and to arrange the remaining circuits on the circuit chip 202.

Note that each of the first and second modification examples can be applied to the third modification example of the first embodiment.

In this manner, according to the third modification example of the first embodiment of the present technology, since circuits are arranged in a distributed manner on the two stacked chips, the circuit scale per chip can be reduced. Thereby, it becomes easier to increase pixels.

### “Fourth Modification Example”

Whereas circuits such as the EVS 300 are arranged on a single semiconductor chip according to the first embodiment mentioned above, this configuration poses difficulty in terms of an increases in pixels, in some cases. The light sensing device 100 according to the fourth modification example of the first embodiment is different from the first embodiment in that circuits are arranged in a distributed manner on three stacked semiconductor chips.

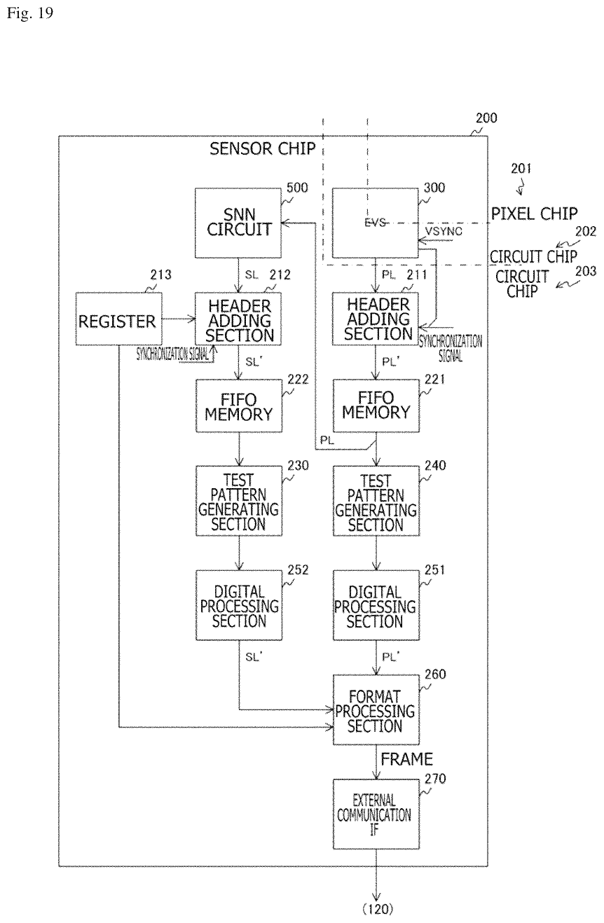

FIG. 19 is a diagram depicting an example of a multilayered structure of the sensor chip 200 according to the fourth modification example of the first embodiment of the present technology. According to the fourth modification example of the first embodiment, the sensor chip 200 includes a stacked pixel chip 201, circuit chip 202 and circuit chip 203. Some of pixels (e.g., the pixel circuit 410, etc.) of the EVS 300 are arranged on the pixel chip 201, and the remaining circuits of the EVS 300 are arranged on the circuit chip 202. In addition, downstream circuits such as the header adding section 211 and circuits thereafter are arranged on the circuit chip 203. Note that circuits to be arranged on each chip are not limited to those illustrated in the diagram. In addition, the number of chips to be stacked is not limited to three but may be equal to or greater than four.

Note that each of the first and second modification examples can be applied to the fourth modification example of the first embodiment.

In this manner, according to the fourth modification example of the first embodiment of the present technology, since circuits are arranged in a distributed manner on the three stacked chips, the circuit scale per chip can be reduced. Thereby, it becomes easier to increase pixels.

### 2. Second Embodiment

Whereas two FIFO memories and two digital processing sections are arranged according to the first embodiment mentioned above, these numbers can also be reduced. The light sensing device 100 according to the second embodiment is different from that the first embodiment in that the FIFO memory 222 and the digital processing section 252 are eliminated.

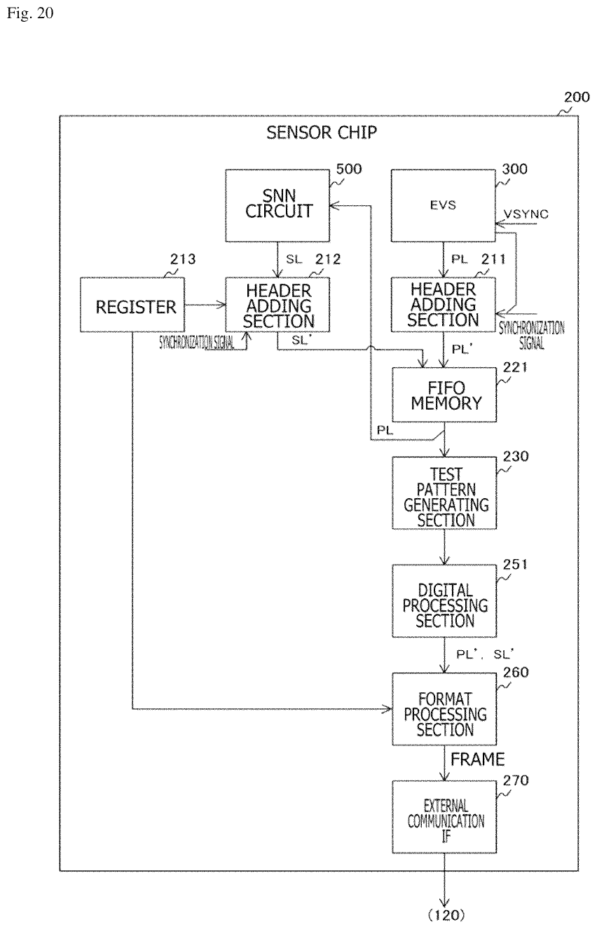

FIG. 20 is a block diagram depicting a configuration example of the sensor chip 200 according to the second embodiment of the present technology. The sensor chip 200 according to the second embodiment is different from the first embodiment in that the FIFO memory 222, the test pattern generating section 240 and the digital processing section 252 are not provided.

In the second embodiment, the header adding section 212 supplies headered SL's to the FIFO memory 221 and the FIFO memory 221 retains the PL's and SL's. In addition, the FIFO memory 221 supplies PLs to the SNN circuit 500 and supplies PL's and SL's to the digital processing section 251 via the test pattern generating section 230. The digital processing section 251 processes PL's and SL's and supplies the PL's and the SL's to the format processing section 260.

Note that each of the first, second, third and fourth modification examples of the first embodiment can be applied to the second embodiment.

In this manner, according to the second embodiment of the present technology, since the FIFO memories 222 and the digital processing section 252 are eliminated, the circuit scale of the sensor chip 200 can be reduced.

### “First Modification Example”

Whereas the FIFO memory 221 retains PLs according to the second embodiment mentioned above and supplies them to the SNN circuit 500, the EVS 300 can also directly output PLs to the SNN circuit 500. The light sensing device 100 according to the first modification example of the second embodiment is different from the second embodiment in that the EVS 300 directly outputs PLs to the SNN circuit 500.

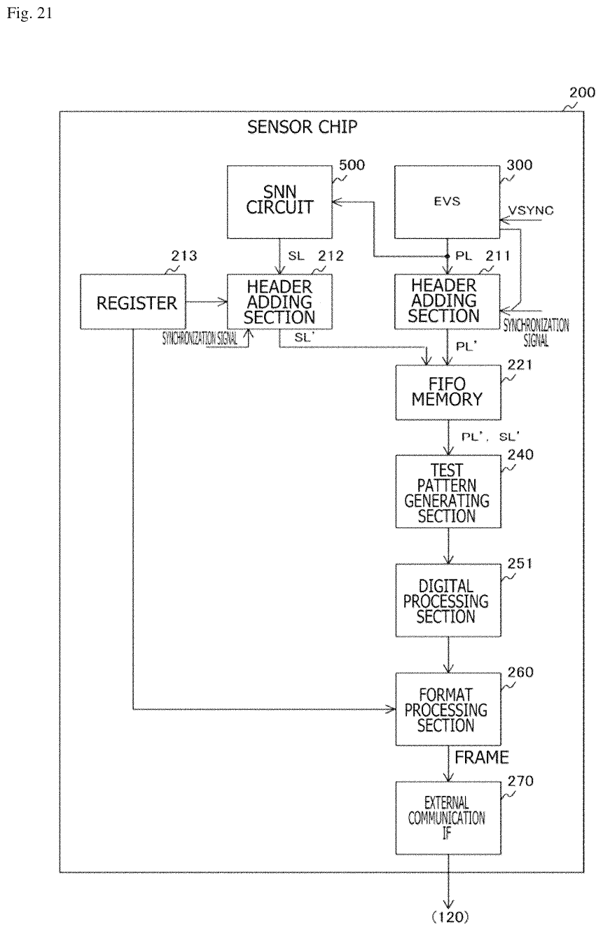

FIG. 21 is a block diagram depicting a configuration example of the sensor chip 200 according to the first modification example of the second embodiment of the present technology. According to the first modification example of the second embodiment, the EVS 300 outputs PLs to the SNN circuit 500 and the header adding section 211 bypasses the FIFO memory 221. By directly outputting PLs to the SNN circuit 500 bypassing the FIFO memory 221, the delays of the SLs relative to the PLs can be shortened.

Note that each of the first, second, third and fourth modification examples of the first embodiment can be applied to the first modification example of the second embodiment.

In this manner, according to the first modification example of the second embodiment of the present technology, since the EVS 300 directly outputs PLs to the SNN circuit 500, the delays of the SLs can be shortened.

### “Second Modification Example”

Whereas the FIFO memory 221 is caused to retain both PL's and SL's according to the second embodiment mentioned above, PL's and SL's can be retained in separate FIFO memories. The light sensing device 100 according to the second modification example of the second embodiment is different from the first embodiment in that PL's and SL's are retained in separate FIFO memories.

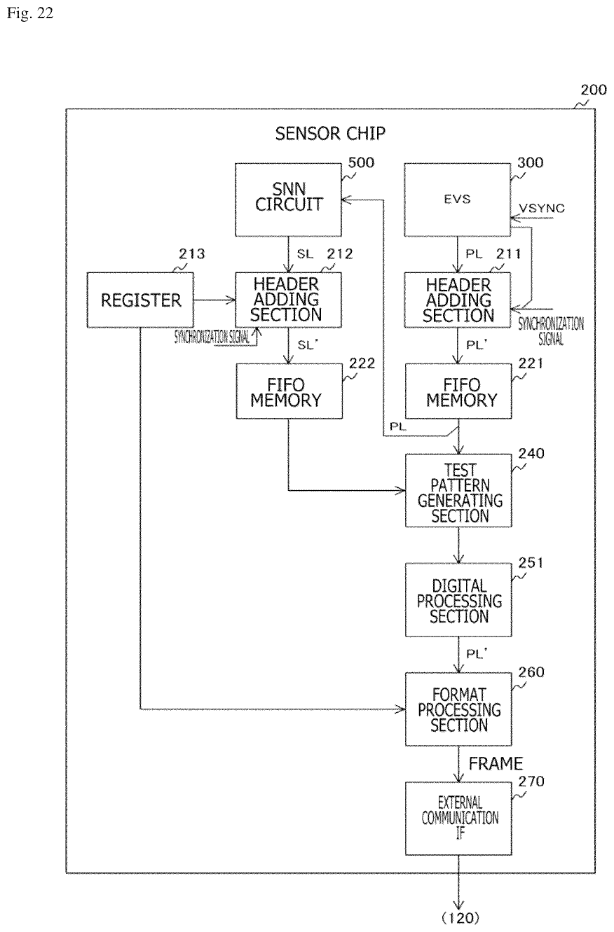

FIG. 22 is a block diagram depicting a configuration example of the sensor chip 200 according to the second modification example of the second embodiment of the present technology. The sensor chip 200 according to the second modification example of the second embodiment is different from the second embodiment in that the FIFO memory 222 is arranged further.

In the second modification example of the second embodiment, the header adding section 212 supplies headered SL's to the FIFO memory 222. The FIFO memory 222 retains the SL's and supplies them to the test pattern generating section 240.

In this manner, according to the second modification example of the second embodiment of the present technology, since the FIFO memory 222 is added, PL's and SL's can be retained in different FIFO memories.

### 3. Third Embodiment

Whereas the EVS 300 is used as a sensor to generate PLs according to the first embodiment mentioned above, a photon measuring circuit to count photons can also be used instead of the EVS 300. The light sensing device 100 according to the third embodiment is different from the first embodiment in that a photon measuring circuit is used instead of the EVS 300.

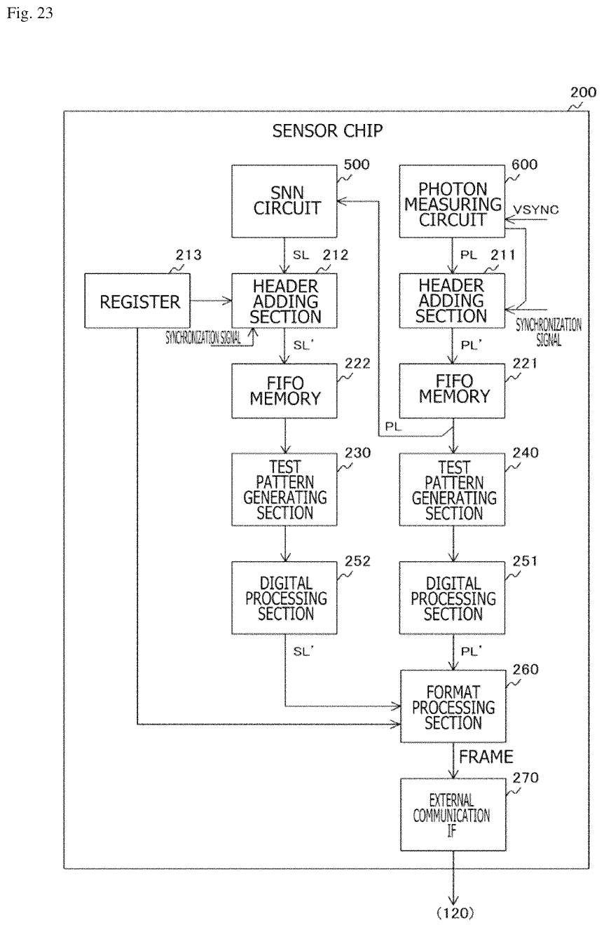

FIG. 23 is a block diagram depicting a configuration example of the sensor chip 200 according to the third embodiment of the present technology. The sensor chip 200 according to the third embodiment is different from the first embodiment in that a photon measuring circuit 600 is arranged instead of the EVS 300. Note that the photon measuring circuit 600 is an example of a sensor described in the claims.

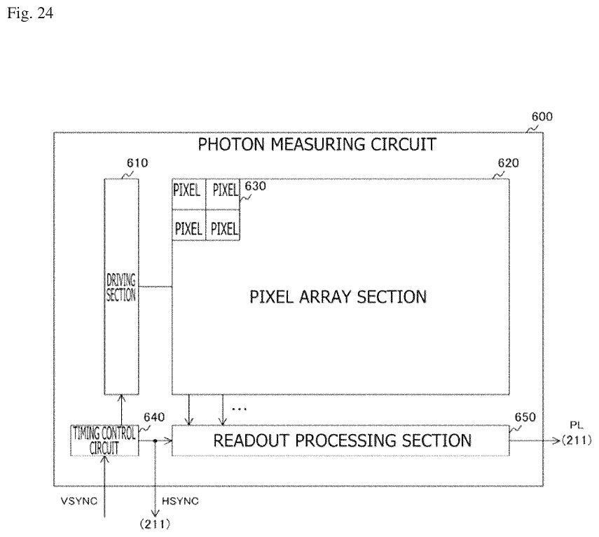

FIG. 24 is a block diagram depicting a configuration example of the photon measuring circuit 600 according to the third embodiment of the present technology. This photon measuring circuit 600 includes a driving section 610, a pixel array section 620, a timing control circuit 640 and a readout processing section 650. Multiple pixels 630 are arrayed in a two-dimensional grid in the pixel array section 620.

Functions of the driving section 610, the pixel array section 620, the timing control circuit 640 and the readout processing section 650 are similar to those of the driving section 310, the pixel array section 320, the timing control circuit 330 and the line scanner 340, respectively.

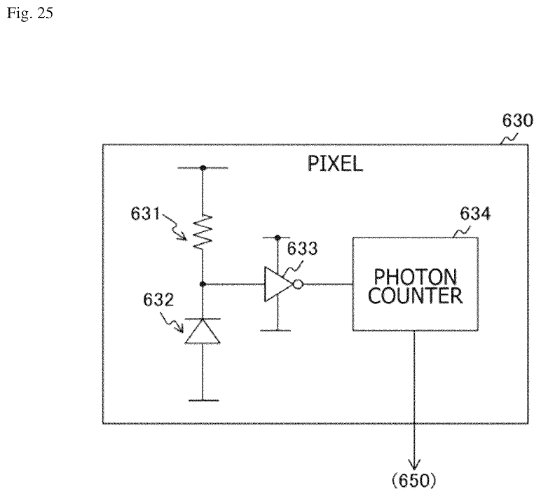

FIG. 25 is a circuit diagram depicting a configuration example of the pixels 630 according to the third embodiment of the present technology. Each pixel 630 includes a quench resistor 631, a Single-Photon Avalanche Diode (SPAD) 632, an inverter 633 and a photon counter 634.

The quench resistor 631 and the SPAD 632 are connected in series. The inverter 633 inverts a voltage signal between the quench resistor 631 and the SPAD 632 and supplies the voltage signal to the photon counter 634 as a pulse signal. The photon counter 634 counts the number of pulses of the pulse signal, reads out pixel data representing a count value and supplies the pixel data to the readout processing section 650.

In a case where photons are counted, each piece of pixel data in the PLs is a bit string with two or more bits representing count values. However, according to the first embodiment, each piece of the pixel data is preferably converted into one-bit information. In a case where conversion is performed, for example, a conversion circuit that converts a bit string into one bit for each pixel is inserted on the upstream side of the SNN circuit 500.

Note that the circuit configuration of the pixels 630 is not limited to the one illustrated in the diagram as long as it can count photons.

In addition, each of the first, second, third and fourth modification examples of the first embodiment, the second embodiment and the first and second modification examples of the second embodiment can be applied to the third embodiment.

In this manner, according to the third embodiment of the present technology, since the photon measuring circuit 600 is arranged instead of the EVS 300, synchronicity can be maintained between the output of the photon measuring circuit 600 and the output of the SNN circuit 500.

### 4. Fourth Embodiment

Whereas the EVS 300 is used as a sensor to generate PLs according to the first embodiment mentioned above, a Contact Image Sensor(CIS) can also be used instead of the EVS 300. The light sensing device 100 according to the fourth embodiment is different from the first embodiment in that a CIS is used instead of the EVS 300.

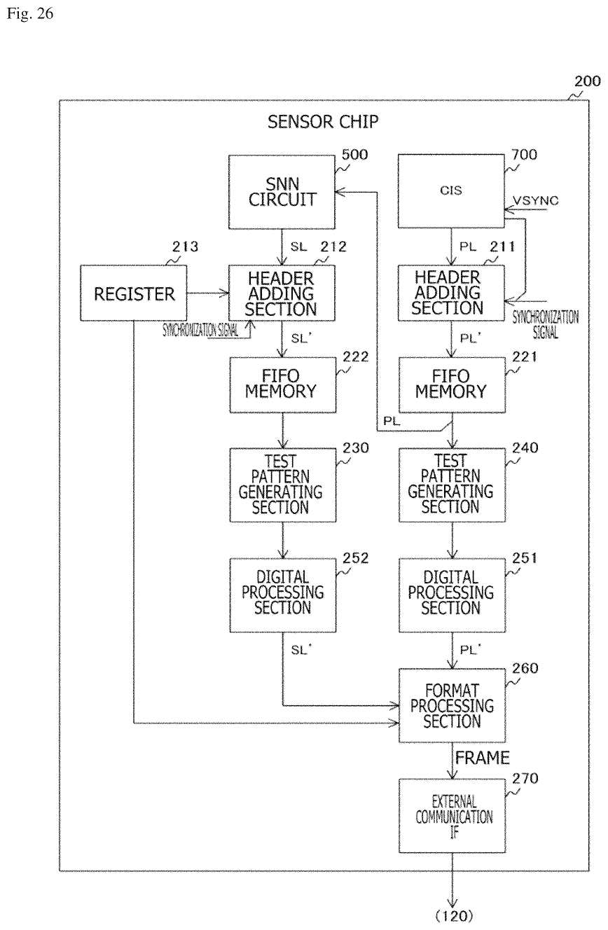

FIG. 26 is a block diagram depicting a configuration example of the sensor chip 200 according to the fourth embodiment of the present technology. The sensor chip 200 according to the fourth embodiment is different from the first embodiment in that a CIS 700 is arranged instead of the EVS 300. Note that the CIS 700 is an example of a sensor described in the claims.

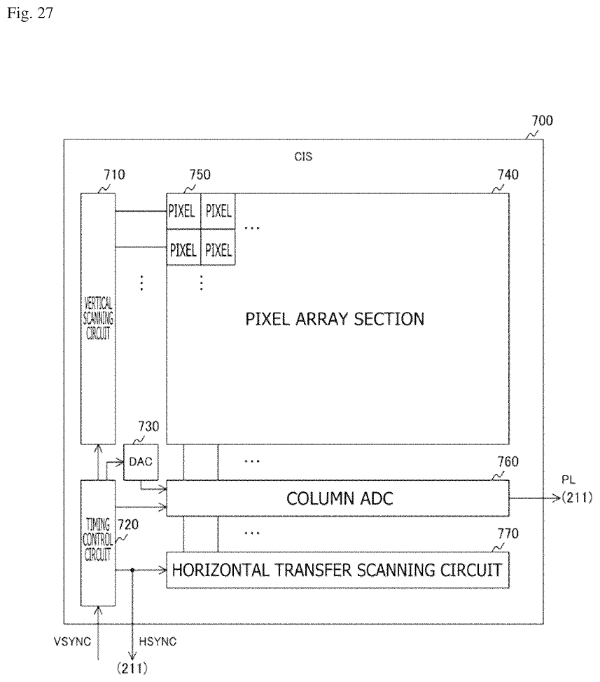

FIG. 27 is a block diagram depicting a configuration example of the CIS 700 according to the fourth embodiment of the present technology. The CIS 700 includes a vertical scanning circuit 710, a timing control circuit 720, a Digital to Analog Converter (DAC) 730, a pixel array section 740, a column Analog to Digital Converter (ADC) 760 and a horizontal transfer scanning circuit 770. Pixels 750 are arrayed in a two-dimensional grid in the pixel array section 740.

The vertical scanning circuit 710 sequentially selects and drives rows and cause the rows to output analog pixel signals to the column ADC 760. The timing control circuit 720 generates the horizontal synchronization signal HSYNC from the vertical synchronization signal VSYNC and supplies the horizontal synchronization signal HSYNC to the horizontal transfer scanning circuit 770 and the header adding sections 211 and 212.

The DAC 730 generates a predetermined reference signal and supplies the predetermined reference signal to the column ADC 760. As a reference signal, a sawtooth-wave-patterned ramp signal is used, for example.

The column ADC 760 includes an ADC for each column and performs Analog to Digital (AD) conversion on respective pixel signals of columns. The column ADC 760 generates PLs according to the control of the horizontal transfer scanning circuit 770 and outputs the PLs to the header adding section 211.

The horizontal transfer scanning circuit 770 controls the column ADC 760 to sequentially output pixel data.

As mentioned above, in the CIS, each piece of pixel data in the PLs is a bit string with two or more bits represent the grayscale values of the pixel. However, as according to the first embodiment, each piece of the pixel data is preferably converted into one-bit information. In a case where conversion is performed, for example, a conversion circuit that converts a bit string into one bit for each pixel is inserted on the upstream side of the SNN circuit 500.

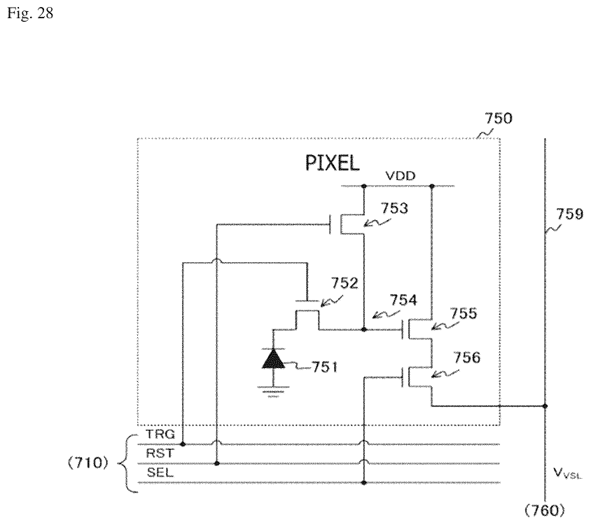

FIG. 28 is a circuit diagram depicting a configuration example of the pixels 750 according to the fourth embodiment of the present technology. A pixel 750 includes a photodiode 751, a transfer transistor 752, a reset transistor 753, a floating diffusion layer 754, an amplification transistor 755 and a selection transistor 756.

The photodiode 751 performs photoelectric conversion on incident light and generates charge. According to a transfer signal TRG from the vertical scanning circuit 710, the transfer transistor 752 transfers charge from the photodiode 751 to the floating diffusion layer 754.

According to a reset signal RST from the vertical scanning circuit 710, the reset transistor 753 draws charge from the floating diffusion layer 754 and initializes the floating diffusion layer 754. The floating diffusion layer 754 accumulates charge and generates a voltage according to the electric charge amount.

The amplification transistor 755 amplifies the voltage of the floating diffusion layer 754. According to a selection signal SEL from the vertical scanning circuit 710, the selection transistor 756 outputs, as a pixel signal, a signal of the voltage after the amplification.

In addition, a vertical signal line 759 is placed for each column in the pixel array section 740 and a pixel signal of each pixel 750 in a column is output to the column ADC 760 via a vertical signal line 759 of the column.

Note that the circuit configuration of the pixels 750 is not limited to the configuration illustrated in the diagram as long as it can generate analog pixel signals.

In addition, each of the first, second, third and fourth modification examples of the first embodiment, the second embodiment and the first and second modification examples of the second embodiment can be applied to the fourth embodiment.

In this manner, according to the fourth embodiment of the present technology, since the CIS 700 is arranged instead of the EVS 300, synchronicity between the output of the CIS 700 and the output of the SNN circuit 500 can be maintained.

### 5. Fifth Embodiment

Whereas the sensor chip 200 transmits the PLs and the SLs according to the first embodiment mentioned above, it is also conceivable that there is a case where only the SLs are necessary in a downstream circuit. The light sensing device 100 according to the fifth embodiment is different from the first embodiment in that the sensor chip 200 transmits only the SLs in the PLs and the SLs.

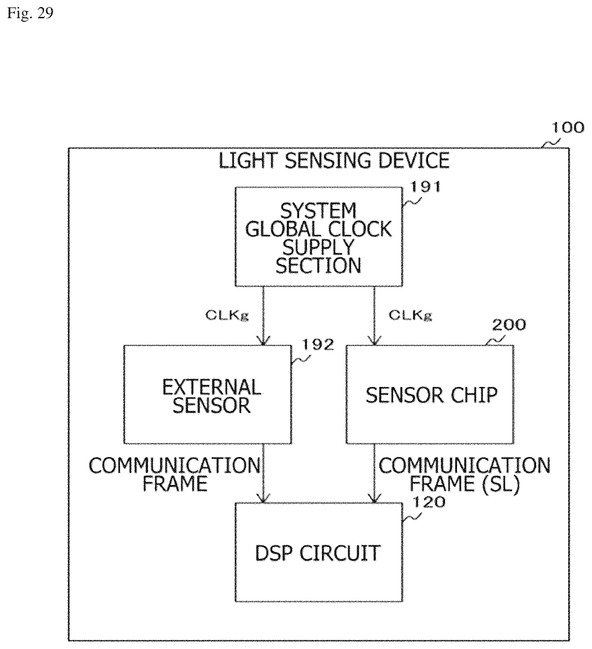

FIG. 29 is a block diagram depicting a configuration example of the light sensing device 100 according to the fifth embodiment of the present technology. The light sensing device 100 includes a system global clock supply section 191, an external sensor 192, the sensor chip 200 and the DSP circuit 120.

The system global clock supply section 191 generates the global clock signal CLKg and supplies the global clock signal CLKg to the external sensor 192 and the sensor chip 200.

The external sensor 192 operates in synchronization with the global clock signal CLKg and transmits to the DSP circuit 120, a communication frame having stored therein predetermined sensor data. Note that various types of devices can also be arranged instead of the external sensor 192.

The sensor chip 200 also operates in synchronization with the global clock signal CLKg. In addition, the sensor chip 200 adds headers, or the like, to the SLs, stores the SLs in a communication frame and transmits the communication frame to the DSP circuit 120. The DSP circuit 120 processes sensor data and the SLs while maintaining synchronicity between the sensor data and the SLs.

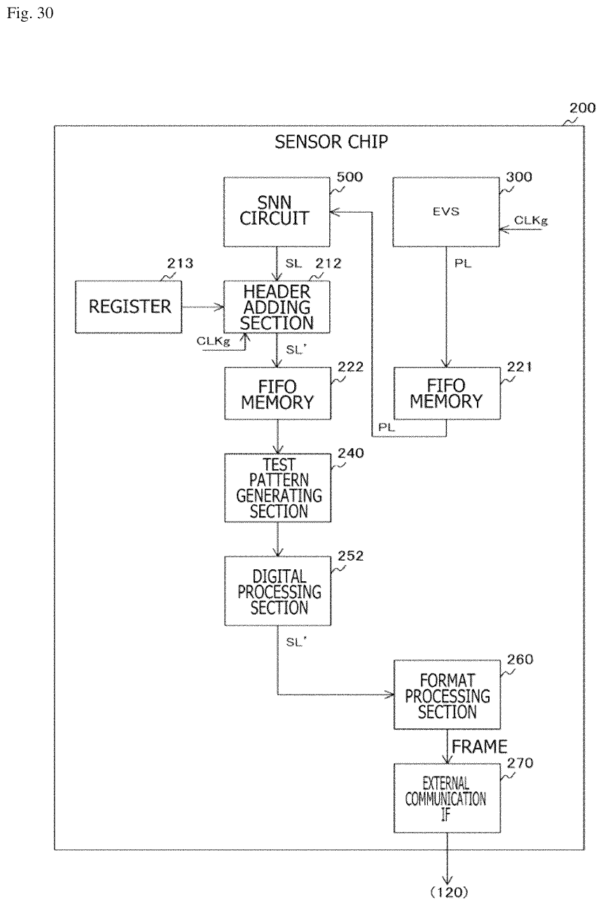

FIG. 30 is a block diagram depicting a configuration example of the sensor chip 200 according to the fifth embodiment of the present technology. The sensor chip 200 according to the fifth embodiment is different from the first embodiment in that the header adding section 211, the test pattern generating section 230 and the digital processing section 251 are not provided.

In the fifth embodiment, the EVS 300 outputs the PLs to the FIFO memory 221. In addition, the format processing section 260 stores headered SL's in a communication frame.

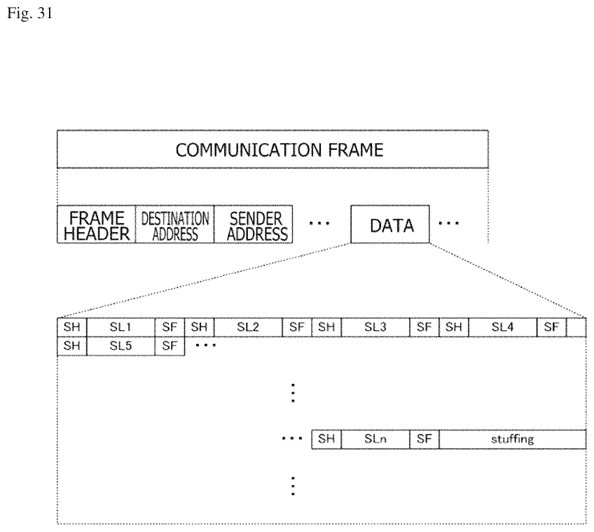

FIG. 31 is a diagram depicting an example of a communication frame format according to the fifth embodiment of the present technology. As illustrated in the diagram, the SL's are stored but the PL's are not stored in a communication frame.

Thereby, a communication amount of the external communication interface 270 can be reduced.

Note that each of the third and fourth modification examples of the multilayered structure of the first embodiment, the third embodiment that uses the photon measuring circuit and the fourth embodiment that uses the CIS can be applied to the fifth embodiment.

In this manner, according to the fifth embodiment of the present technology, since the format processing section 260 does not store the PL's in a communication frame, a communication amount of the external communication interface 270 can be reduced.

### 6. Examples of Application to Mobile Bodies

The technology according to the present disclosure (present technology) can be applied to various products. For example, the technology according to the present disclosure may be realized as a device to be mounted on any type of mobile body such as an automobile, an electric automobile, a hybrid electric automobile, a motorcycle, a bicycle, a personal mobility, an airplane, a drone, a ship, or a robot, or the like.

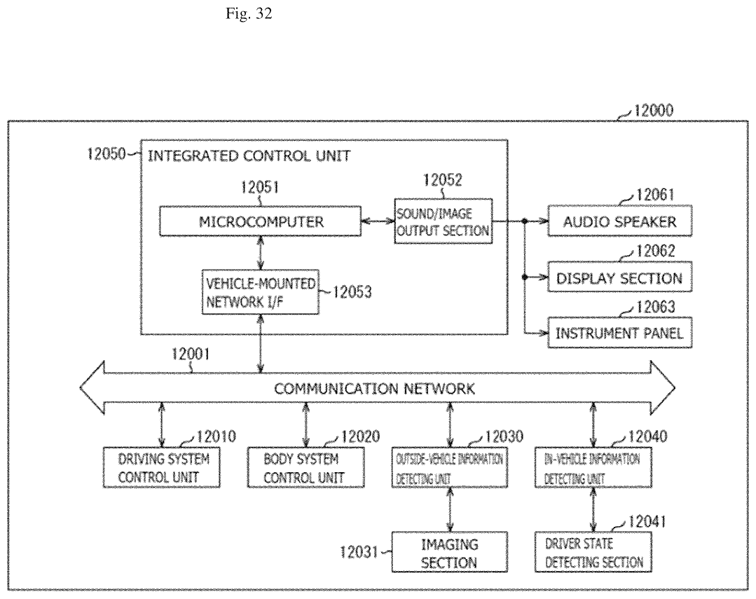

FIG. 32 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 32, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches, can be input to the body system control unit 12020. The body system control unit 12020 receives these input radio waves or signals, and controls a door lock device, the power window device, the lamps, or the, like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 instructs the imaging section 12031 to provide an image of an outside of the vehicle and then receives the image from the imaging section 12031. Based on the received image, the outside-vehicle information detecting unit 12030 processes the received image to detect objects such as a human, a vehicle, an obstacle, a sign, a character on a road surface, or the like, or processes the received image to detect distances from the object.

The imaging section 12031 is an optical sensor that receives light, and which outputs an electrical signal corresponding to a received amount of light. The imaging section 12031 can output the electric signal as an image or can output the electrical signal as information about a measured distance. In addition, the light received by the imaging section 12031 may be visible light or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver or may determine whether the driver is dozing off.

The microcomputer 12051 can calculate a control target value for the driving force generating device, the steering mechanism, or the braking device based on the information about the inside or outside of the vehicle obtained by the outside-vehicle information detecting unit 12030 or the in-vehicle information detecting unit 12040 and can output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, (e.g., operating the vehicle without input from the driver, or the like), by controlling the driving force generating device, the steering mechanism, the braking device, or the like, based on information about the outside or inside of the vehicle obtained by the outside-vehicle information detecting unit 12030 or the in-vehicle information detecting unit 12040.

In addition, the microcomputer 12051 can output a control command to the body system control unit 12020 based on the information about the outside of the vehicle obtained by the outside-vehicle information detecting unit 12030. For example, the microcomputer 12051 can perform cooperative control intended to prevent a glare by controlling the headlamp to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 32, an audio speaker 12061, a display section 12062, and an instrument panel 12063 are illustrated as the output device. The display section 12062 may, for example, include at least one of an on-board display and a head-up display.

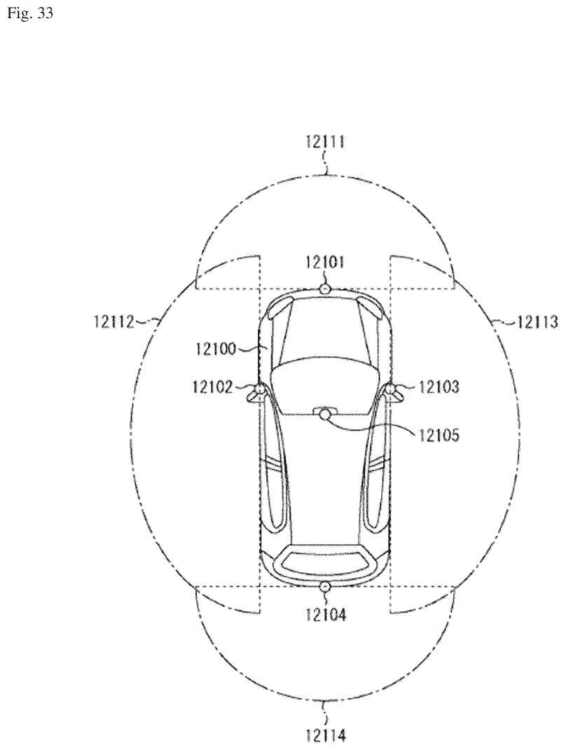

FIG. 33 is a diagram depicting an example of the installation position of the imaging section 12031.

In FIG. 33, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle, obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door, obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 33 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by super-imposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance and perform automatic brake control (including following stop control), automatic acceleration control (including following start control), or the like. It is thus possible to perform cooperative control intended for automated driving that allows the vehicle to operate in an automated manner without depending on input from the driver, or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062 and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether there is a pedestrian in images of the imaging sections 12101 to 12104. Such recognition of a pedestrian is, for example, performed by a procedure of extracting characteristic points in the images of the imaging sections 12101 to 12104 as infrared cameras and a procedure of determining whether it is the pedestrian by performing pattern matching processing on a series of characteristic points representing the contour of the object. When the microcomputer 12051 determines that there is a pedestrian in the images of the imaging sections 12101 to 12104, and thus recognizes the pedestrian, the sound/image output section 12052 controls the display section 12062 so that a square contour line for emphasis is displayed to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been explained thus far. The technology according to the present disclosure can be applied to the imaging section 12031 in the configuration explained above, for example. Specifically, the light sensing device 100 in FIG. 1 can be applied to the imaging section 12031. Since synchronization between the output of the EVS 300 and the output of the SNN circuit 500 becomes easier by applying the technology according to the present disclosure to the imaging section 12031, the system's performance can be enhanced.

Note that the embodiments mentioned above are depicted as examples for embodying the present technology and matters in the embodiments and disclosure specifying matters in claims are correlated, respectively. Similarly, disclosure specifying matters in claims and matters in the embodiments of the present technology that are given names which are identical to those of the disclosure specifying matters are correlated, respectively. It should be noted that the present technology is not limited to the embodiments but can be embodied by making various modifications to the embodiments within the scope not departing from the gist thereof.

Note that advantageous effects described in the present specification are illustrated merely as examples, but are not the sole examples, and also there may be other advantageous effects.

Note that the present technology can also have the following configurations.

(1)

A light detecting device, comprising:
a sensor configured to output a plurality of first line data including a plurality of pixel data;
neural network circuitry configured to: process at least one of the plurality of first line data; and
output second line data including a result of the processing; and
a communication interface configured to transmit a communication frame including the at least one of the plurality of first line data and the second line data,
wherein the communication interface include:
a first header including identification information for the at least one of the plurality of first line data;
the at least one of the plurality of first line data;
a second header including identification information for the second line data; and the second line data.
   (2)

The light detecting device according to 1, wherein the first header is added to each of the at least one of the plurality of first line data.

(3)

The light detecting device according to 1, wherein the first header is added to each of a group of the at least one of the plurality of first line data.

(4)

The light detecting device according to 1, wherein the second header is added to each of the second line data.

(5)

The light detecting device according to 1, wherein the second header is added to each of a group of the second line data.

(6)

The light detecting device according to 1, wherein the identification information includes time information.

(7)

The light detecting device according to 1, wherein the identification information includes line number information.

(8)

The light detecting device according to 6, wherein the time information includes a time at which the at least one of the plurality of first line data has been output.

(9)

The light detecting device according to 7, wherein the line information includes a line number for the at least one of the plurality of first line data.

(10)

The light detecting device according to 1, wherein the first line data of the plurality of first line data is output in an asynchronous manner.

(11)

The light detecting device according to 1, wherein the second line data is provided between at least one of the plurality of first line data.

(12)

The light detecting device according to 1, wherein the sensor includes an Event-based Vision Sensor (EVS), a photon counting sensor or a Contact Image Sensor(CIS).

(13)

The light detecting device according to 1 further comprising a first chip and a second chip,
wherein the first chip is stacked on the second chip,
wherein pixels of the sensor are provided in the first chip, and
wherein a pixel readout circuitry is provided in the second chip.
   (14)

The light detecting device according to 13, further comprising a third chip,
wherein first and second chips are stacked on the third chip and
wherein the communication interface is provided in the third chip.
   (15)

A processing device, comprising:
circuity configured to:
receive a communication frame from a light detecting device,
wherein the light detecting device includes a sensor configured to output a plurality of first line data including a plurality of pixel data; and
neural network circuitry configured to:
process at least one of the plurality of first line data; and
   output second line data including a result of the processing,
wherein the communication frame includes:
a first header including identification information for the at least one of the plurality of first line data;
the at least one of the plurality of first line data;
a second header including identification information for the second line data; and the second line data.
   (16)

The processing device according to 15, wherein the first header is added to each of the at least one of the plurality of first line data.

(17)

The processing device according to 15, wherein the first header is added to each of a group of the at least one of the plurality of first line data.

(18)

The processing device according to 15, wherein the second header is added to each of the second line data.

(19)

The processing device according to 15, wherein the second header is added to each of a group of the second line data.

(20)

The processing device according to 15, wherein the identification information includes time information.

(21)

The processing device according to 15, wherein the identification information includes line number information.

(22)

The processing device according to 20, wherein the time information includes a time at which the at least one of the plurality of first line data has been output.

(23)

The processing device according to claim 21, wherein the line information includes a line number for the at least one of the plurality of first line data.

(24)

The processing device according to 15, wherein the first line data of the plurality of first line data is output in an asynchronous manner.

(25)

The processing device according to 15, wherein the second line data is provided between at least one of the plurality of first line data.

(26)

The processing device according to 15, wherein the sensor includes an Event-based Vision Sensor (EVS), a photon counting sensor or a Contact Image Sensor(CIS).

(27)

The processing device according to 25 further comprising a first chip and a second chip,
wherein the first chip is stacked on the second chip,
wherein pixels of the sensor are provided in the first chip, and
wherein a pixel readout circuitry is provided in the second chip.
   (28)

The processing device according to 27, further comprising a third chip,
wherein first and second chips are stacked on the third chip and
wherein the communication frame is provided in the third chip.

### (B1)

A light sensing device including:
a sensor that outputs a predetermined number of pieces of first line data each including multiple pieces of pixel data;
a neural network circuit that sequentially processes a predetermined number of pieces of the first line data on a basis of a neural network model, and outputs second line data including an array of results of the processing on each of the predetermined number of pieces of the first line data; and
a format processing section that generates a communication frame having stored therein a predetermined number of pieces of the first line data and the second line data in association with each other.

### (B2)

The light sensing device according to (B1) above, further including:
a first header adding section that adds, to the first line data, a first header including predetermined information; and
a second header adding section that adds, to the second line data, a second header including the predetermined information.

### (B3)

The light sensing device according to (B2) above, in which the first header adding section adds the first header to each of a predetermined number of pieces of the first line data.

### (B4)

The light sensing device according to (B2) above, in which the first header adding section adds the first header to first line data at a beginning of a predetermined number of pieces of the first line data.

### (B5)

The light sensing device according to (B2) or (B3) above, in which the second header adding section adds the second header to each of a predetermined number of pieces of the second line data.

### (B6)

The light sensing device according to (B2) or (B3) above, in which the second header adding section adds the second header to second line data at a beginning of a predetermined number of pieces of the second line data.

### (B7)

The light sensing device according to any one of (B2) to (B6) above, in which the predetermined information includes time information representing a time at which the first line data has been output.

### (B8)

The light sensing device according to any one of (B2) to (B6) above, in which the pixel data includes time information, and
the predetermined information includes identification information regarding lines corresponding to the first line data.

### (B9)

The light sensing device according to any one of (B8) above, further including:
a digital processing section that performs a predetermined process on the first line data to which the first header has been added, and the second line data to which the second header has been added, and supplies the first line data and the second line data to the format processing section.

### (B10)

The light sensing device according to any one of (B2) to (B8) above, including:
a first digital processing section that performs a predetermined process on the first line data to which the first header has been added, and supplies the first line data to the format processing section; and
a second digital processing section that performs a predetermined process on the second line data to which the second header has been added, and supplies the second line data to the format processing section.

### (B11)

The light sensing device according to any one of (B2) to (B10) above, further including:
a FIFO (First In, First Out) memory that retains, by a first-in first-out scheme, the first line data to which the first header has been added, and the second line data to which the second header has been added.

### (B12)

The light sensing device according to any one of (B2) to (B10) above, further including:
a first FIFO memory that retains, by a first-in first-out scheme, the first line data to which the first header has been added; and
a second FIFO memory that retains, by a first-in first-out scheme, the second line data to which the second header has been added.

### (B13)

The light sensing device according to (B12) above, in which the neural network circuit reads out the first line data from the first FIFO memory.

### (B14)

The light sensing device according to (B12) above, in which the sensor outputs the first line data to the first FIFO memory and the neural network circuit.

### (B15)

The light sensing device according to any one of (B1) to (B14) above, in which the sensor includes an EVS (Event-based Vision Sensor).

### (B16)

The light sensing device according to any one of (B1) to (B14) above, in which the sensor includes a photon measuring circuit that counts photons.

### (B17)

The light sensing device according to any one of (B1) to (B14) above, in which the sensor include CISs (CMOS Image Sensors).

### (B18)

The light sensing device according to any one of (B1) to (B17) above, in which the sensor, the neural network circuit, and the format processing section are arranged dis-tributedly on multiple stacked chips.

### (B19)

A light sensing device including:
a sensor that outputs a predetermined number of pieces of first line data each including multiple pieces of pixel data;
a neural network circuit that sequentially processes a predetermined number of pieces of the first line data on a basis of a neural network model, and outputs second line data including an array of results of the processing on each of the predetermined number of pieces of the first line data;
a header adding section that adds, to the second line data, a header including predetermined information regarding the first line data; and
a format processing section that generates a communication frame having stored therein the second line data to which the header has been added.

### (B20)

A light-sensing-device control method including:
a procedure of, by a sensor, outputting a predetermined number of pieces of first line data each including multiple pieces of pixel data;
a procedure of, by a neural network circuit, sequentially processing a predetermined number of pieces of the first line data on a basis of a neural network model, and
outputting second line data including an array of results of the processing on each of the predetermined number of pieces of the first line data; and
a procedure of, by a format processing section, generating a communication frame having stored therein a predetermined number of pieces of the first line data and the second line data in association with each other.

### REFERENCE SIGNS LIST

100: Light sensing device
110: Optics section
120: Digital Signal Processor (DSP) circuit
130: Display section
140: Manipulation section
150: Bus
160: Frame memory
170: Storage section
180: Power supply section
191: System global clock supply section
192: External sensor
200: Sensor chip
201: Pixel chip
202, 203: Circuit chip
211, 212: Header adding section
213: Register
221, 222, 541 to 545: First-In First-Out (FIFO) memory
230, 240: Test pattern generating section
231: Test pattern supply section
232: Switch
251, 252: Digital processing section
260: Format processing section
261: Buffer memory
262: Rearrangement processing section
263: Formatter
270: External communication interface
300: Event-based Vision Sensor (EVS)
310, 610: Driving section
320, 620, 740: Pixel array section
330, 640, 720: Timing control circuit
340: Line scanner
400, 630, 750: Pixel
410: Pixel circuit
411, 751: Photodiode
412, 413, 435, 442, 444: negative channel Metal-Oxide-Semiconductor (nMOS) transistor
414, 421, 422, 432, 434, 441, 443: positive channel (pMOS) transistor
420: Buffer
430: Differentiation circuit
431, 433: Capacitor
440: Quantizer
500: Simulated Neural Network (SNN) circuit
511: Input layer
512: Interlayer
513: Output layer
520: Input/output (I/O) interface
530: Multicore array
540: Router
546: Arbiter
550: Core
551: Core router
552: Neuron I/O
553: Sum-of-products unit
554: Work memory
555: Membrane potential memory
556: Leaky Integrate and Fire (LIF) unit
600: Photon measuring circuit
631: Quench resistor
632: Single-Photon Avalanche Diode (SPAD)
633: Inverter
634: Photon counter
650: Readout processing section
700: Contact Image Sensor(CIS)
710: Vertical scanning circuit
730: Digital to Analog Converter (DAC)
752: Transfer transistor
753: Reset transistor
754: Floating diffusion layer
755: Amplification transistor
756: Selection transistor
760: Column Analog to Digital Converter (ADC)
770: Horizontal transfer scanning circuit

What is claimed is:

1. A light detecting device, comprising:
a sensor configured to output a plurality of first line data including a plurality of pixel data;
neural network circuitry configured to:
process at least one of the plurality of first line data; and
output second line data including a result of the processing; and
a communication interface configured to transmit a communication frame including the at least one of the plurality of first line data and the second line data,
wherein the communication interface include:
a first header including identification information for the at least one of the plurality of first line data;
the at least one of the plurality of first line data;
a second header including identification information for the second line data; and
the second line data.

2. The light detecting device according to claim 1, wherein the first header is added to each of the at least one of the plurality of first line data.

3. The light detecting device according to claim 1, wherein the first header is added to each of a group of the at least one of the plurality of first line data.

4. The light detecting device according to claim 1, wherein the second header is added to each of the second line data.

5. The light detecting device according to claim 1, wherein the second header is added to each of a group of the second line data.

6. The light detecting device according to claim 1, wherein the identification information includes time information.

7. The light detecting device according to claim 1, wherein the identification information includes line number information.

8. The light detecting device according to claim 6, wherein the time information includes a time at which the at least one of the plurality of first line data has been output.

9. The light detecting device according to claim 7, wherein the line information includes a line number for the at least one of the plurality of first line data.

10. The light detecting device according to claim 1, wherein the first line data of the plurality of first line data is output in an asynchronous manner.

11. The light detecting device according to claim 1, wherein the second line data is provided between at least one of the plurality of first line data.

12. The light detecting device according to claim 1, wherein the sensor includes an Event-based Vision Sensor (EVS), a photon counting sensor or a Contact Image Sensor (CIS).

13. The light detecting device according to claim 1 further comprising a first chip and a second chip,
wherein the first chip is stacked on the second chip,
wherein pixels of the sensor are provided in the first chip, and
wherein a pixel readout circuitry is provided in the second chip.

14. The light detecting device according to claim 13, further comprising a third chip,
wherein first and second chips are stacked on the third chip and
wherein the communication interface is provided in the third chip.

15. A processing device, comprising:
circuity configured to:
receive a communication frame from a light detecting device,
wherein the light detecting device includes a sensor configured to output a plurality of first line data including a plurality of pixel data; and
neural network circuitry configured to:
process at least one of the plurality of first line data; and
output second line data including a result of the processing,
wherein the communication frame includes:
a first header including identification information for the at least one of the plurality of first line data;
the at least one of the plurality of first line data;
a second header including identification information for the second line data; and
the second line data.

16. The processing device according to claim 15, wherein the first header is added to each of the at least one of the plurality of first line data.

17. The processing device according to claim 15, wherein the first header is added to each of a group of the at least one of the plurality of first line data.

18. The processing device according to claim 15, wherein the second header is added to each of the second line data.

19. The processing device according to claim 15, wherein the second header is added to each of a group of the second line data.

20. The processing device according to claim 15, wherein the identification information includes time information.

21. The processing device according to claim 15, wherein the identification information includes line number information.

22. The processing device according to claim 20, wherein the time information includes a time at which the at least one of the plurality of first line data has been output.

23. The processing device according to claim 21, wherein the line information includes a line number for the at least one of the plurality of first line data.

24. The processing device according to claim 15, wherein the first line data of the plurality of first line data is output in an asynchronous manner.

25. The processing device according to claim 15, wherein the second line data is provided between at least one of the plurality of first line data.

26. The processing device according to claim 15, wherein the sensor includes an Event-based Vision Sensor (EVS), a photon counting sensor or a Contact Image Sensor (CIS).

27. The processing device according to claim 25 further comprising a first chip and a second chip,
wherein the first chip is stacked on the second chip,
wherein pixels of the sensor are provided in the first chip, and
wherein a pixel readout circuitry is provided in the second chip.

28. The processing device according to claim 27, further comprising a third chip,
wherein first and second chips are stacked on the third chip and
wherein the communication frame is provided in the third chip.
